(19) United States
(12) Patent Application Publication
(10) Pub. No.: US 2025/0304381 A1
(43) Pub. Date: Oct. 2, 2025

(54) AGGREGATED TO ORGANIZED AUTOMATED LINE LOADING SYSTEM AND METHOD

(71) Applicant: JBT Marel Corporation, Chicago, IL (US)

(72) Inventors: Jon A. Hocker, Redmond, WA (US); Christian Moser, Auckland (NZ); Alec W.W. Hewitt, Loveland, CO (US); Jonathan James Keogh, Snoqualmie, WA (US); Bartholomeus Marinus Martinus Kivits, Eindhoven (NL); Richard D. Stockard, San Diego, CA (US)

(73) Assignee: JBT Marel Corporation, Chicago, IL (US)

(21) Appl. No.: 19/093,727

(22) Filed: Mar. 28, 2025

Related U.S. Application Data
(60) Provisional application No. 63/571,910, filed on Mar. 29, 2024.
(60) Provisional application No. 63/749,443, filed on Jan. 24, 2025.

(51) Int. Cl. B65G 47/28; B07C 5/342; B65G 47/19

(52) U.S. Cl. CPC B65G 47/28; B07C 5/3422; B65G 47/19; B65G 2201/047; B65G 2203/0233; B65G 2203/0241; B65G 2203/041

(57) ABSTRACT

An automated infeed system may including a primary organization assembly configured to perform a primary workpiece organization to an aggregated supply of workpieces; an organization assessment assembly having at least one sensor configured to capture sensor data regarding the primary workpiece organization; a secondary organization assembly configured to perform a secondary workpiece organization based on the sensor data regarding the primary workpiece organization; and a movement assembly configured to move workpieces within the automated infeed system.

### CROSS-REFERENCES TO RELATED APPLICATIONS

This application claims the benefit of U.S. Provisional Application No. 63/571,910, filed Mar. 29, 2024, and U.S. Provisional Application No. 63/749,443, filed Jan. 24, 2025, both of which applications are entirely incorporated herein by reference.

### BACKGROUND

Workpiece processing flow typically includes feeding an aggregated or bulk supply of workpieces to a workpiece processing machine. The bulk supply typically must be organized for workpiece processing. Systems and methods described herein optimize the bulk supply to organized workpiece feeding process.

### SUMMARY

In some aspects, the techniques described herein relate to an automated infeed system, including: a primary organization assembly configured to perform a primary workpiece organization to an aggregated supply of workpieces; an organization assessment assembly having at least one sensor configured to capture sensor data regarding the primary workpiece organization; a secondary organization assembly configured to perform a secondary workpiece organization based on the sensor data regarding the primary workpiece organization; and a movement assembly configured to move workpieces within the automated infeed system.

In some aspects, the techniques described herein relate to an automated infeed system configured to transition an aggregated supply of workpieces to a substantially continuous flow of workpieces, including: a receiving assembly configured to receive an aggregated supply of workpieces; a workpiece flow distribution assembly configured to distribute workpieces across at least one of a length and width of a movement assembly, wherein the workpiece flow distribution assembly includes: a staggered roller assembly having a plurality of powered rollers in series, each roller rotating about its longitudinal axis at a speed different from at least one other roller; and a vibration assembly configured to receive workpieces from the staggered roller assembly, the vibration assembly configured to facilitate at least one of spreading, placement, orientation, and arrangement of the workpieces.

In some aspects, the techniques described herein relate to an automated line loading management system for a workpiece processing system, including: an automated infeed system, including: a primary organization assembly configured to perform a primary workpiece organization to an aggregated supply of workpieces; an organization assessment assembly having at least one sensor configured to capture sensor data regarding the primary workpiece organization; a secondary organization assembly configured to perform a secondary workpiece organization; a movement assembly configured to move workpieces through the automated infeed system; a processor; and a memory storing instructions that, when executed by the processor, cause a computing device of the automated line loading management system to: process the sensor data regarding the primary workpiece organization to determine at least one of workpiece mass flow, workpiece position, workpiece orientation, workpiece spacing, and workpiece arrangement; and execute a secondary organization algorithm based on the processed sensor data and workpiece processing specifications to generate movement instructions for at least one secondary organization component of the secondary organization assembly to move a secondary organization component into a position for adjusting at least one of workpiece position, workpiece orientation, workpiece spacing, and workpiece arrangement.

In some aspects, the techniques described herein relate to a method of organizing an infeed of workpieces to a workpiece processing system, the method including: performing, with one or more primary organization components, a primary workpiece organization to an aggregated supply of workpieces to define primarily organized workpieces; capturing, with at least one sensor of an organization assessment assembly, sensor data of the primarily organized workpieces; performing, with one or more secondary organization components, a secondary workpiece organization to the primarily organized workpieces to define secondarily organized workpieces, the secondary workpiece organization based on an analysis of the sensor data of the primarily organized workpieces; and moving the secondarily organized workpieces to an infeed of a workpiece processing system.

In some aspects, the techniques described herein relate to a primary organization assembly configured to perform a primary workpiece organization to a bulk supply of workpieces, the primary organization assembly including: a workpiece receiving assembly having a bulk supply receiving subassembly configured to receive a bulk supply of workpieces from a bulk storage transfer assembly; a workpiece flow metering assembly configured to meter a mass flow of the bulk supply of workpieces through the primary organization assembly using at least one image sensor configured to obtain image sensor data of workpieces on a primary organization assembly conveyor; a workpiece flow modulating assembly including: a bulk supply deposit assembly configured to controllably deposit at least a portion of the bulk supply of workpieces from a bulk storage container to a buffering subassembly of the workpiece receiving assembly; a thickness control subsystem configured to cause at least one of stacked and overlapping workpieces to at least one of move back upstream for redistribution and to be substantially prevented from moving downstream with a movement assembly; a workpiece flow distribution assembly configured to create separation of the workpieces in a direction of flow; and a primary organization controller configured to output control instructions to the bulk supply deposit assembly to control at least one of a speed, a direction, and a frequency of the bulk supply deposit assembly based on the image sensor data of workpieces.

In some aspects, the techniques described herein relate to an automated infeed system, including: a primary organization assembly configured to perform a primary workpiece organization to a bulk supply of workpieces, the primary organization assembly including: a workpiece receiving assembly having a bulk supply receiving subassembly configured to receive a bulk supply of workpieces from a bulk storage transfer assembly; a workpiece flow metering assembly configured to meter a mass flow of the bulk supply of workpieces through the primary organization assembly; and a workpiece flow modulating assembly including: a bulk supply deposit assembly configured to controllably deposit at least a portion of the bulk supply of workpieces from a bulk container to a buffering subassembly of the workpiece receiving assembly; a thickness control subsystem configured to cause at least one of stacked and overlapping workpieces to at least one of move back upstream for redistribution and to be substantially prevented from moving downstream with a movement assembly; and a workpiece flow distribution assembly configured to create separation of the workpieces in a direction of flow; an organization assessment assembly having at least one sensor configured to capture sensor data regarding the primary workpiece organization; a processor; and a memory storing instructions that, when executed by the processor, cause a computing device of the automated infeed system to: process the sensor data regarding the primary workpiece organization to determine at least one of workpiece mass flow, workpiece position, workpiece orientation, workpiece spacing, and workpiece arrangement; and execute a primary organization algorithm based on the processed sensor data and workpiece processing specifications to generate modulating instructions for the workpiece flow modulating assembly including a bulk supply deposit assembly profile having at least one of a deposit speed, a deposit position, and a deposit frequency of the bulk supply deposit assembly.

In some aspects, the techniques described herein relate to a method of organizing an infeed of workpieces to a workpiece processing system, the method including: receiving, with a bulk supply receiving subassembly, a bulk storage container having a bulk supply of workpieces; depositing, with a bulk supply deposit assembly, at least a portion of the bulk supply of workpieces from the bulk storage container to a buffering subassembly of the workpiece receiving assembly; metering a mass flow of the deposited workpieces through the buffering subassembly using at least one image sensor configured to obtain image sensor data of the deposited workpieces on a primary organization assembly conveyor; substantially preventing at least one of stacked and overlapping deposited workpieces from moving downstream with the primary organization assembly conveyor; substantially separating workpieces in a direction of flow; and outputting control instructions via a controller to the bulk supply deposit assembly to control at least one of a speed, a direction, and a frequency of the bulk supply deposit assembly based on the image sensor data of the deposited workpieces to modulate the flow of workpieces deposited onto the primary organization assembly conveyor.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### BRIEF DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 shows a block diagram of a non-limiting example of an automated line loading management system according to various aspects of the present disclosure.

FIG. 2A shows a block diagram of a non-limiting example of a primary organization assembly according to various aspects of the present disclosure.

FIG. 2B shows a side view of an exemplary bulk transfer assembly according to various aspects of the present disclosure.

FIG. 2C shows a side view of an exemplary workpiece supply assembly and an exemplary primary organization component assembly according to various aspects of the present disclosure.

FIG. 2D shows an isometric view of an exemplary primary organization component assembly according to various aspects of the present disclosure.

FIG. 2E shows a first isometric view of another exemplary primary organization component assembly according to various aspects of the present disclosure.

FIG. 2F shows a second isometric view of the exemplary primary organization component assembly of FIG. 2E.

FIG. 3 shows a block diagram of a non-limiting example of an organization assessment assembly according to various aspects of the present disclosure.

FIG. 4 shows a block diagram of a non-limiting example of a secondary organization assembly according to various aspects of the present disclosure.

FIG. 5 shows a first isometric view of portions of an exemplary automated infeed system according to various aspects of the present disclosure.

FIG. 6 shows a second isometric view of the exemplary automated infeed system of FIG. 5.

FIG. 7 shows an isometric view of portions of an exemplary automated infeed system according to various aspects of the present disclosure.

FIG. 8 shows an isometric view of portions of an exemplary automated infeed system according to various aspects of the present disclosure.

FIG. 9 is a block diagram of a non-limiting example of a data processing computing device according to various aspects of the present disclosure.

FIG. 10A shows a side view of an exemplary automated line loading management system according to various aspects of the present disclosure.

FIG. 10B shows a top view of the exemplary automated line loading management system of FIG. 10.

FIG. 11 shows an isometric view of an exemplary automated line loading management system according to various aspects of the present disclosure.

FIG. 12 a flowchart that illustrates a non-limiting example of a method of organizing an infeed of workpieces to a workpiece processing system.

FIG. 13 is a block diagram that illustrates a non-limiting example of a computing device appropriate for use as a computing device with examples of the present disclosure.

### DETAILED DESCRIPTION

Workpiece processing machines are typically fed an aggregated or bulk amount of workpieces on an incoming conveyance system that must be spread out, oriented, arranged or otherwise organized in order to be optimally processed by the machine. With regard to industrial food processing machines, such as portioners, injectors, ovens, freezers, breaders, fryers, packagers, etc., the incoming bulk supply of food products are typically deposited from a large tote (e.g., a 1,000 or 2,000 pound tote) into a hopper system, which then deposits the products onto an infeed conveyance system. The hopper system may be capable of providing an initial spreading of the food products as they are deposited onto the infeed conveyance system, but the food products are still often overlapping, doubled-up, stacked, spaced inappropriately, or incorrectly oriented (such as being head first v. tail first, skin side up v. down, on its side v. on a top or bottom, etc.).

Industrial food processing machines typically have threshold requirements for product arrangement and spacing to optimally process those products. For instance, a high-speed portioning machine, which may be used to portion, trim, or otherwise cut a food product into smaller pieces in accordance with customer needs, must have the food products sufficiently spread out on the conveyor belt without overlapping or doubled-up product. Although these machines use various scanning and data processing techniques to ascertain parameters of the incoming food product to determine how to most efficiently cut the food product, cutting can be further optimized by optimally organizing, arranging or orienting the food products (such as being head first v. tail first, skin side up v. down, etc.). Further, although sufficient spacing between food products is needed, through-put can be optimized if the spacing is minimized (the “belt loading density”). Similar requirements exist for other food processing machines, such as injectors, ovens, freezers, breaders, fryers, etc.

In most instances, the incoming, bulk supply of product is arranged manually by workers standing next to the infeed conveyance system. The workers can spread, remove doubled-up or stacked product, orient, and arrange the products according to machine and/or customer specifications. Many workers can fit into a small length of the infeed conveyance system (e.g., 800 mm of belt length) to arrange a significant supply of incoming bulk product. However, manual labor is costly and unreliable. Some efforts have been made to replace manual labor with robotic systems. However, such systems often require a significant amount of space on the line, and thus they are impractical for crowded or dense facilities.

Aspects of the present disclosure are directed to an automated line loading management system and method. An automated line loading management system and method formed in accordance with the present disclosure includes an automated infeed system configured to automatically transition an incoming, aggregated supply of workpieces into a continuous, organized flow of workpieces at an infeed of a processing machine. Using an automated line loading management system and method as disclosed herein, a workpiece processor can reduce or eliminate manual labor normally required for organizing an incoming, bulk, batch supply of workpieces. Further, such manual labor can be replaced without increasing an overall footprint of an infeed system and without sacrificing quality of workpiece organization or throughput. The foregoing benefits as well as other benefits will be further appreciated from the description that follows.

In the present disclosure, references to “food,” “food products,” “food pieces,” “food items,” “pieces,” “portions,” etc., are used interchangeably and are meant to include all manner of foods. Such foods may include meat, fish, poultry, plant-based products, fruits, vegetables, nuts, or other types of foods. Also, the automated line loading system and method disclosed herein is directed to raw food products, as well as partially and/or fully processed or cooked food products.

Further, automated line loading systems and methods disclosed herein, though sometimes described with specific applicability to food products or food items, may also be used outside of the food area. Accordingly, the present disclosure may reference “workpieces,” “products”, “components”, “samples”, etc., which terms are synonymous with each other. It is to be understood that references to “workpieces,” “products”, “components”, “samples”, etc., also include food, food products, food pieces, food items, etc. Moreover, references to “food”, “food products”, “food pieces”, “food items”, “pieces”, “portions”, etc., also include “workpieces,” “products”, “components”, “samples”, etc.

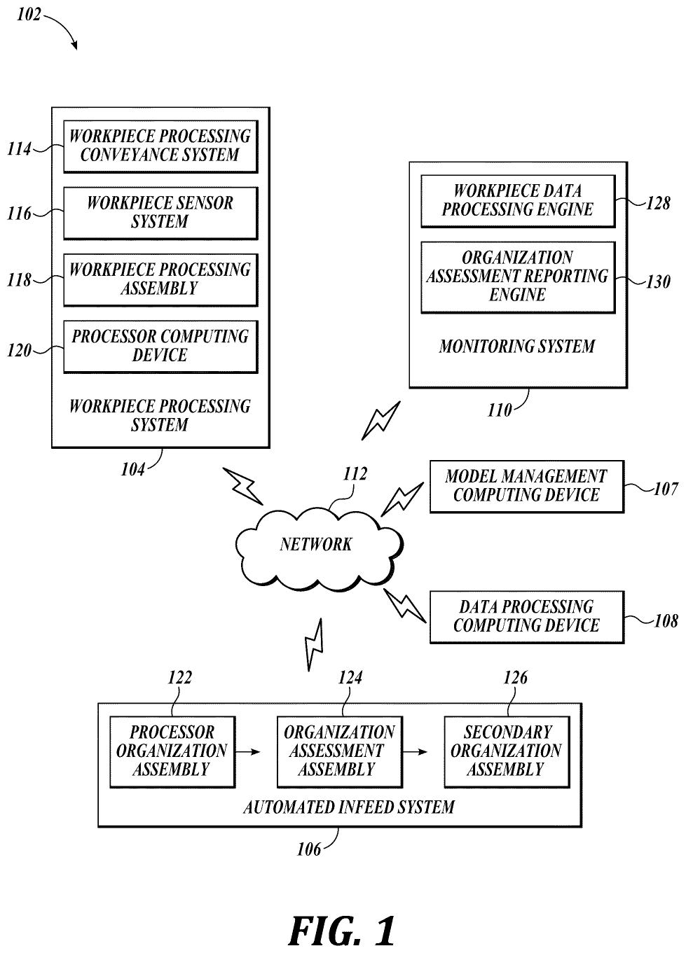

FIG. 1 depicts a schematic illustration of a non-limiting example of an automated line loading management system 102 that can be used to manage an automatic transition of an incoming, aggregated supply of workpieces into a substantially continuous, organized flow of workpieces for delivery to an infeed of a processing machine. The automated line loading management system 102 may include various components and networked computing devices configured for managing aspects of automatically transitioning an incoming, aggregated supply of workpieces into a substantially continuous, organized flow.

In the depicted example, the automated line loading system 102 includes a workpiece processing system 104, an automated infeed system 106, a model management computing device 107, a data processing computing device 108, and a monitoring system 110 communicatively coupled together through a network 112. The network 112 can be any kind of network capable of enabling communication between the various components of the automated line loading system 102. For example, the network can be a WiFi network.

Exemplary aspects of the workpiece processing system 104 will first be described. The processing system 104 is generally configured to carry out processing of workpieces after the workpieces have been organized and/or transitioned from an aggregated supply into a continuous flow by the automated infeed system 106. In that regard, the workpiece processing system 104 includes a workpiece processing conveyance system 114 or another movement device configured to carry workpieces between various portions of the processing system. For instance, the workpiece processing conveyance system 114 may carry workpieces from an infeed end, where the workpiece processing system 104 receives workpieces from the automated line loading management system 102, toward an outfeed end. Along the way, the workpiece processing conveyance system 114 may carry workpieces past a workpiece sensor system 116, where one or more sensors may be used to gather data regarding the workpieces. For instance, the workpiece sensor system 116 may include a scanner station, a weight measurement station, a temperature station, etc., configured to capture image data, weight data, and temperature data, respectively, of the workpieces, etc.

The workpiece processing conveyance system 114 may also carry workpieces to various components of a workpiece processing assembly 118, which may be configured to carry out one or more processing operations on the workpiece. In an example of a portioner, the components may include one or more of a slicer, a cutter station, a pick-up station, a sorter, and a packager. In an example of an oven, the components may include one or more of an air circulation assembly, a spiral belt assembly, a moisture control assembly, etc. The components of the workpiece processing assembly 118 may be controlled by a processor computing device 120.

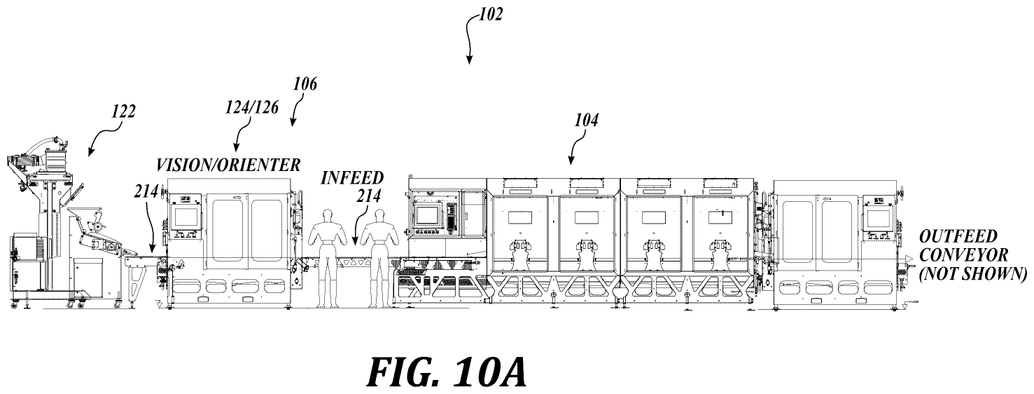

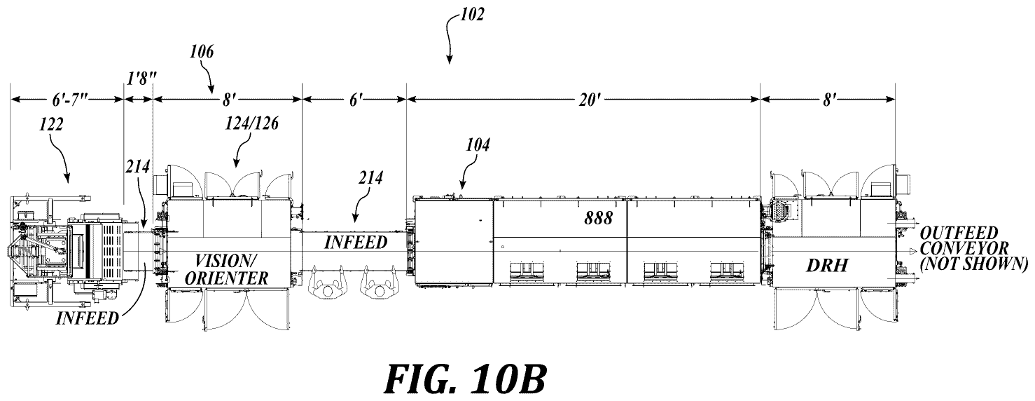

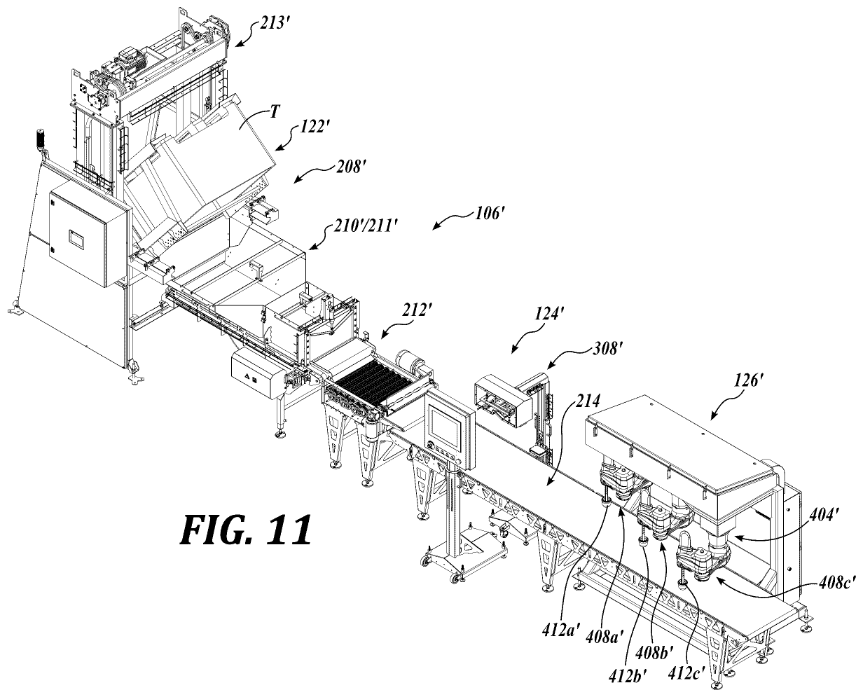

Of course, any other suitable workpiece processing system having other suitable components may instead be used. For instance, the processing system 104 may incorporate aspects of a portioner system, such as those shown and described in U.S. Pat. No. 7,651,388, entitled “Portioning apparatus and method”, U.S. Pat. No. 7,672,752, entitled “Sorting workpieces to be portioned into various end products to optimally meet overall production goals”, and U.S. Pat. No. 8,688,267, entitled “Classifying workpieces to be portioned into various end products to optimally meet overall production goals”, hereby incorporated by reference herein in their entirety (see also FIGS. 10 and 11). The processing system 104 may incorporate aspects of the thermal processing systems, such as those shown and described in U.S. Patent App. Pub. No. US20070131215A1, entitled “Continuous cooking oven system”, U.S. Patent App. Pub. No. US20180213801A1, entitled “Spiral conveyor thermal processing system”, and U.S. Pat. No. 10,912,317B2, entitled “Thermal processing apparatus.”

Exemplary aspects of the automated infeed system 106 will now be described. The automated infeed system 106 is generally configured to receive an incoming, unorganized supply of workpieces and transition the supply into a substantially organized flow of workpieces. It should be appreciated that the term “organization” may be used to reference any change in a workpiece(s) position, orientation, spacing, arrangement, etc., to support infeed workpiece machine processing needs. If the incoming supply of workpieces is presented in an aggregated format, such as in bulk and/or batch format, the automated infeed system 106 may also be configured to transition the supply into a substantially continuous flow of workpieces.

In the depicted example, the automated infeed system 106 includes a primary organization assembly 122 configured to carry out an initial or primary organization of the workpieces, an organization assessment assembly 124 configured to assess the quality of the initial organization, and a secondary organization assembly 126 configured to carry out a second, more precise organization of the workpieces. In some examples, the automated infeed system 106 may include a second organization assessment assembly configured to assess the quality of the second organization, and/or the organization assessment assembly 124 may also be configured to assess the quality of the second organization. In some examples, the automated infeed system 106 may include only the primary organization assembly 122 and the organization assessment assembly 124.

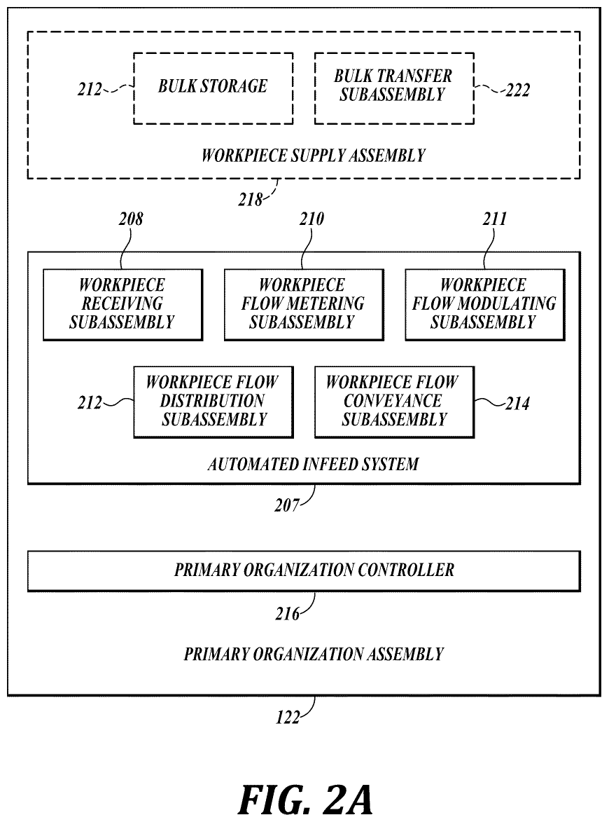

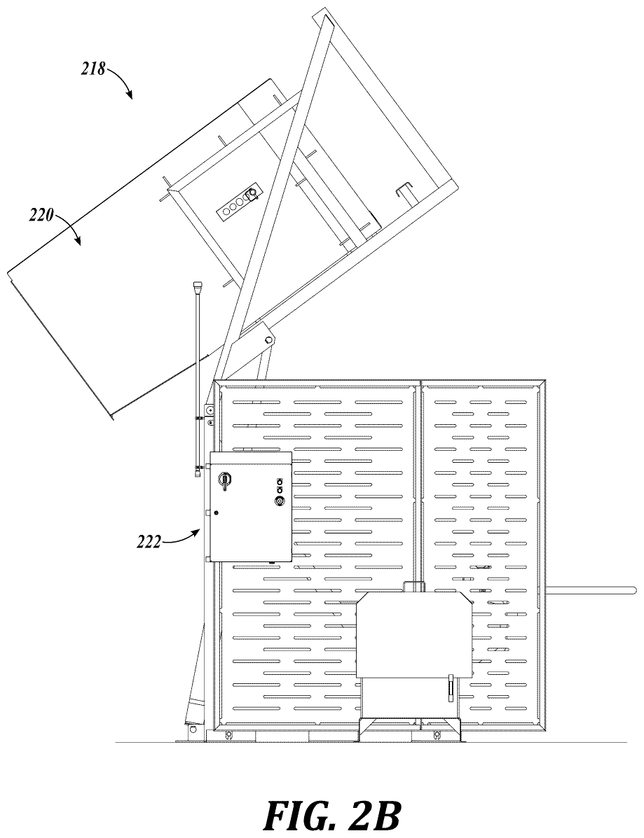

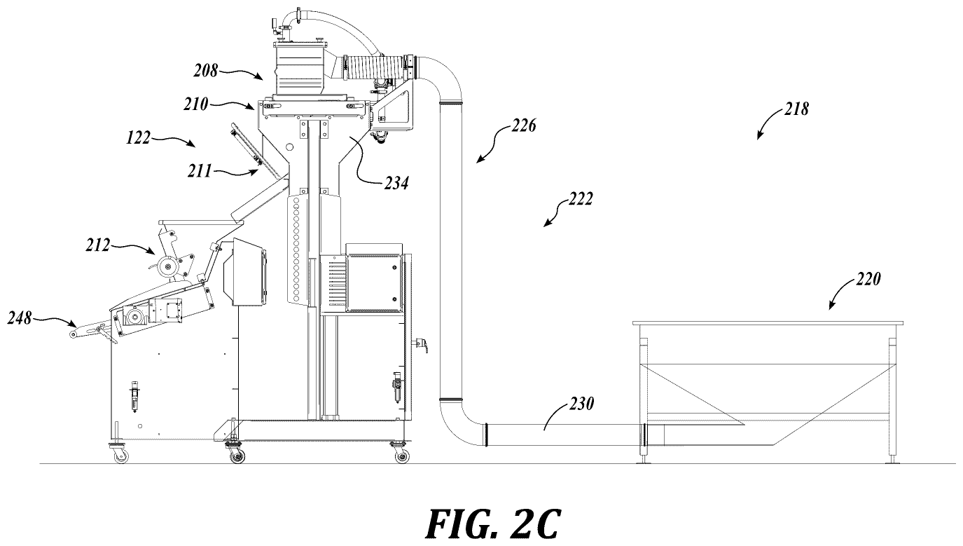

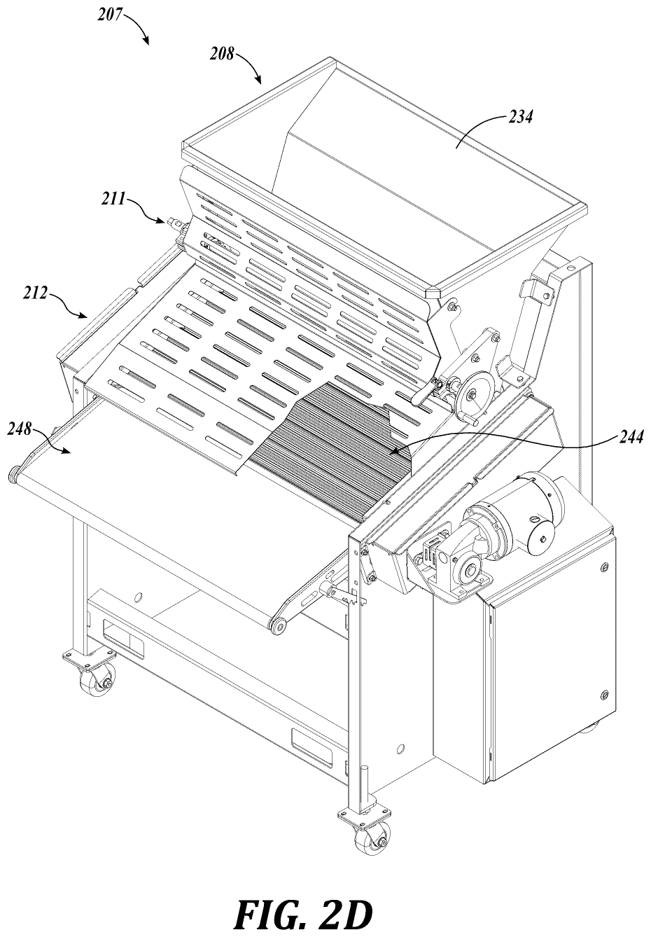

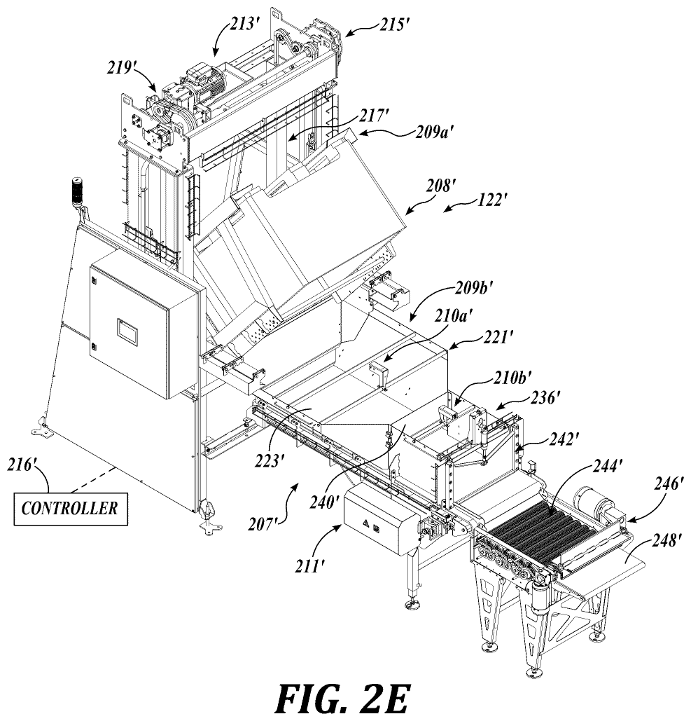

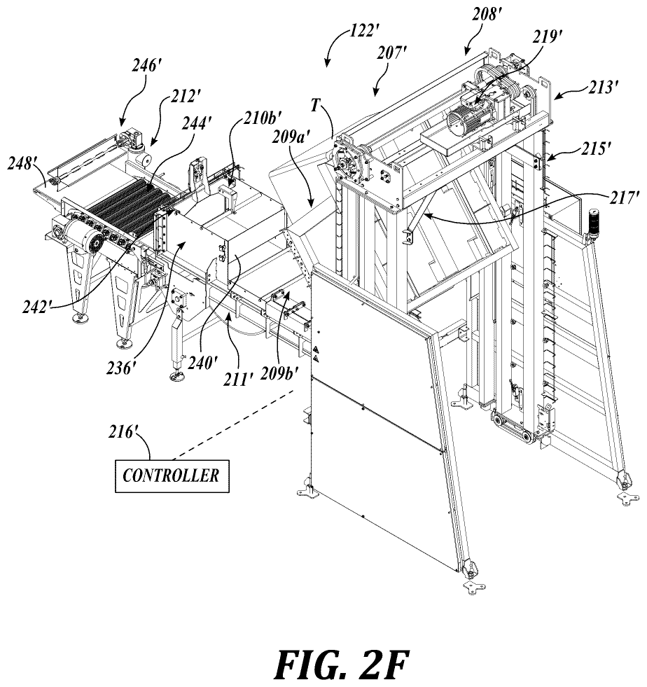

The primary organization assembly 122 will first be described with additional reference to FIG. 2A. As noted above, the primary organization assembly 122 is configured to carry out an initial organization of the unorganized, aggregated workpieces. In that regard, the primary organization assembly 122 may include a primary organization component assembly 207 having one or more components, subassemblies, or the like that are configured to carry out a primary organization of the workpieces. The primary organization component assembly 207 may include a workpiece receiving assembly 208, a workpiece flow metering assembly 210, a workpiece flow modulating assembly 211, and a workpiece flow distribution assembly 212. It should be appreciated that the various components described as being a part of the workpiece receiving assembly 208, the workpiece flow metering assembly 210, the workpiece flow modulating assembly 211, and/or the workpiece flow distribution assembly 212 may instead or additionally form a part of another assembly of the primary organization component assembly 207. The primary organization assembly 122 may further include a primary organization controller 216 (and/or other controllers or computing devices) configured to control one or more components, subassemblies, etc., of the primary organization component assembly, such as with a PID loop, in response to output instructions from a machine learning model, etc.

The workpiece receiving assembly 208 is generally configured to receive a supply of workpieces and feed that supply to other components of the primary organization component assembly, such as the workpiece flow metering assembly 210, the workpiece flow modulating assembly 211, and the workpiece flow distribution assembly 212. For instance, the workpiece receiving assembly 208 may be a suitably large hopper, funnel, or other type of buffering assembly configured to receive a desired supply of workpieces and direct those workpieces toward another component of the primary organization assembly 122. If tapered in overall shape, as with a hopper or funnel, the workpiece receiving assembly 208 may be configured to slowly release/direct a portion of the mass of workpieces. In that regard, the hopper, funnel, etc., includes a suitable opening(s) on its bottom and/or side thereof for directing a desired mass of workpieces toward another component. Moreover, the workpiece receiving assembly 208 may be elevated from the ground such that it may benefit from the force of gravity to feed workpieces to the workpiece flow metering assembly 210, and/or the workpiece flow distribution assembly 212.

Workpieces may be supplied to the elevated workpiece receiving assembly 208 in any suitable manner. For instance, the primary organization assembly 122 may further include or may be configured to be associated with a workpiece supply assembly 218. In many instances, a supply of workpieces is in aggregated format, such as a large (bulk), predefined amount (batch) of workpieces in a large tote. In that regard, the workpiece supply assembly 218 may have an aggregated or bulk storage 220 and/or an aggregated or bulk transfer subassembly 222.

The bulk storage 220 may be a large tote or other container suitable for carrying/transporting a desired amount or weight of workpieces. In the example of food products being supplied to an industrial food processing machine, such as a portioner, the tote may be a 2,000-pound tote of single chicken breast fillets (or heavier) to be portioned, cut, trimmed, etc. In some examples, a smaller container is used, such as a 200-pound tote. It should be appreciated that any other suitable size or type of bulk storage 220 may be used.

Referring to FIG. 2B, the bulk transfer subassembly 222 may be a lifting or elevation device suitable to elevate the bulk storage 220 between a first height (e.g., ground height) and a second, raised height of the workpiece receiving assembly 208. If the bulk storage 220 is a large tote suitable for carrying a desired amount of workpieces (e.g., a 2,000-pound tote of single chicken breast fillets), the bulk transfer subassembly 222 may be a bin tipping system, a tote dumper, or the like, such as that shown in FIG. 2B. For instance, the FTNON bin tipping system™ or the AHK lifting and tipping device™, both available from JBT Corporation of Chicago, IL may be used. The bin tipping system, tote dumper, etc., may elevate and drop workpieces into the workpiece receiving assembly 208.

In other examples, an elevated feed conveyor/hopper system may be used. For instance, a hopper at a lower end of an elevated, endless, gooseneck conveyor system, may receive workpieces from a tote or similar, such as via a bin tipping system or tote dumper. The workpieces may fall from the hopper onto a conveyor belt of the endless, gooseneck conveyor system. The conveyor belt includes cleats or other transverse protrusions, which bring product upwardly with the conveyor belt as it rotates around rollers. When the workpieces reach an upper end of the conveyor system, the workpieces are dropped into the workpiece receiving assembly 208.

In other examples, the bulk transfer subassembly 222 may include a pump feed system to move workpieces from a tote or hopper to the workpiece receiving assembly 208. For instance, the bulk transfer assembly 222 may use the vacuum pump system used in the C.A.T. VacCAT Product Distribution System™, available from JBT Corporation of Chicago, IL, also shown and described in U.S. Pat. No. 7,541,549, entitled “Vacuum transfer apparatus having load isolation weighing system including a rigid pipe section pivotally mounted to a support frame”, incorporated in its entirety herein. In other examples, an air compressor system may be used to move workpieces with high pressure.

An example of a bulk transfer subassembly 222 having a pump feed system 226 is shown in FIG. 2C. The pump feed system 226 may include a transportation pipe(s) 230 extending from a bulk storage hopper 220 configured as hopper. The pipe(s) 230 extend to the workpiece receiving assembly 208, and a suitable pump system (e.g., a vacuum pump with density-based separation, not shown) is configured to move workpieces through the pipe(s). If the bulk storage 220 is a hopper, as shown, the hopper may include a pump outlet configured to be placed into communication with the transportation pipe(s) 230 for workpiece withdrawal. If the bulk storage 220 is instead a tote, a suitable infeed end of the transportation pipe(s) 230 may be placed inside the tote for workpiece withdrawal.

It should be appreciated that any other suitable bulk transfer assembly 222 may be used.

In any event, the bulk storage 220 and/or the bulk transfer subassembly 222 may be considered a part of the primary organization assembly 122 and/or they may be considered separate from the primary organization assembly 122. In that regard, the primary organization assembly 122 may be configured to receive an incoming supply of workpieces in any suitable manner.

As noted above, the workpiece receiving assembly 208 (e.g., a hopper, funnel, or the like), upon receiving workpieces from the workpiece supply assembly 218 or another suitable assembly, feeds the workpieces to one of the components of the primary organization assembly 122. For instance, the incoming supply of workpieces may flow, by gravity, from the workpiece receiving assembly 208 to the workpiece flow metering assembly 210, the workpiece flow modulating assembly 211, and/or the workpiece flow distribution assembly 212. Aspects of the workpiece flow metering assembly 210 will first be described.

The workpiece flow metering assembly 210 may generally be configured to meter a mass flow of workpieces through the primary organization assembly 122. In that regard, the workpiece flow metering assembly 210 may include one or more sensors that can be used to determine a weight, volume, quantity, or other metric for metering the mass flow of workpieces through the primary organization assembly 122.

The one or more sensors and/or controllers may be configured to meter or track the mass flow of workpieces into the workpiece receiving assembly 208 and/or the mass flow of workpieces leaving the workpiece receiving assembly 208. In some examples, the workpiece flow metering assembly 210 may include one or more sensors and/or controllers associated with components of the workpiece supply assembly 218 for measuring a target mass flow of workpieces to the workpiece receiving assembly 208 and/or supplying a target mass flow of workpieces to the workpiece receiving assembly 208.

For instance, one or more pressure sensors may be used to measure and/or adjust the mass flow of workpieces through a vacuum pipe system (e.g., pump feed system 226) into the workpiece receiving assembly 208 to target a mass of workpieces flowing into the workpiece receiving assembly 208 from the vacuum feed pipe (e.g., pipe(s) 230). In other instances, one or more weight measurement sensors may be used to measure a weight of a supply hopper or tote at defined increments of time, and a position encoder may be used to determine a position of a tote dumper, elevated conveyor, etc., used to supply workpieces from that hopper/tote to the workpiece receiving assembly 208. The corresponding weight and position measurements may be used to approximate the mass flow of workpieces into the workpiece receiving assembly 208. For instance, based on historical data for a certain type of workpiece (e.g., chicken breast fillets that flow into a hopper at a specific rate), the mass flow of workpieces may be approximated.

In some examples, the workpiece flow metering assembly 210 may include one or more sensors and/or controllers associated with components of the workpiece receiving assembly 208 for measuring a mass flow of workpieces through the workpiece receiving assembly 208. For instance, the workpiece flow metering assembly 210 may include a weight measurement sensor(s), such as a strain gauge, a load cell, or the like, associated with the workpiece receiving assembly 208 such that it can obtain a weight measurement of the workpieces in the workpiece receiving assembly 208.

With reference to the specific example shown in FIG. 2C, if the workpiece receiving assembly 208 is a hopper 234, the hopper may be mounted via a load cell to a frame of the primary organization assembly 122. For instance, the load cell and hopper assembly used in the C.A.T. VacCAT Product Distribution System™, available from JBT Corporation of Chicago, IL, also shown and described in U.S. Pat. No. 7,541,549, incorporated herein, may be used. In such an example, the workpiece receiving assembly 208 may be considered a part of the workpiece flow metering assembly 210.

In another example, the workpiece flow metering assembly 210 may include one or more image sensors used to capture image data of workpieces within the workpiece receiving assembly 208. Image sensor data may be used by the primary organization controller 216 or another computing device in communication therewith to determine a mass flow of workpieces within the workpiece receiving assembly 208. The image sensor data may be used to determine mass flow by determining a volume of workpieces (e.g., workpiece fill level) within a hopper of the workpiece receiving assembly 208, such as for each batch. The image sensors may be one or more of a structured light scanner, a video camera, a still optical camera, a stereo camera, etc., mounted relative to the workpiece receiving assembly 208 for capturing image data of workpieces deposited therewithin. The scanners used in the systems and methods described herein exclude any type of scanning that could be done by human observation, which would not support the needed processing speed and accuracy of the automated infeed system 106 or the automated line loading management system 102.

Weight measurement data of the workpiece flow metering assembly 210 may be sent to the primary organization controller 216 for processing and/or controlling components of the primary organization assembly 122 and/or the automated line loading management system 102. For instance, if an actual weight of a batch of workpieces in the workpiece receiving assembly 208 is different than an expected weight, the primary organization controller 216 may output a signal(s) to a controller of the workpiece supply assembly 218 indicative of the actual weight of the workpieces so that an incoming supply may be adjusted as needed. For instance, if the primary organization controller 216 has data stored thereon indicating an expected mass flow of workpieces, the controller may output a signal to the workpiece supply assembly 218 to provide more or less workpieces to the workpiece receiving assembly 208 based on an actual weight of the workpieces in the workpiece receiving assembly 208.

In some examples, the primary organization controller 216 may output a signal(s) to the workpiece flow modulating assembly 211 to adjust or modulate the flow of incoming workpieces based on the supply. In that regard, the workpiece flow modulating assembly 211 may include one or more actuators that can be used to activate a mechanism of the workpiece supply assembly 218 for modulating the incoming, upstream supply of workpieces. For instance, in some examples, the workpiece flow modulating assembly 211 may include an actuator configured to activate a tote dump, an elevated conveyance system, a vacuum pump system, etc., of the workpiece supply assembly 218 to adjust the supply of workpieces to the workpiece receiving assembly 208. In that regard, the bulk transfer subassembly 222 may be again considered a part of the workpiece flow modulating assembly 211.

In some examples, the workpiece flow modulating assembly 211 may include one or more actuators that can be used to activate a mechanism of the workpiece receiving assembly 208 for modulating a downstream supply of workpieces. For instance, the workpiece flow modulating assembly 211 may include an actuator configured to activate a hopper gate of the workpiece receiving assembly 208 (such as for hopper 234 shown in FIG. 2C). The actuator may open or close the gate to allow workpieces to flow downstream out of a hopper of the workpiece receiving assembly 208, such as towards the workpiece flow distribution assembly 212.

The workpiece flow modulating assembly 211 may incorporate the actuator and other mechanisms used in the C.A.T. VacCAT Product Distribution System™ available from JBT Corporation of Chicago, IL, also shown and described in U.S. Pat. No. 7,541,549, incorporated herein. Thus, further detailed aspects of the actuators, hopper gate, etc., will not be described for brevity.

In some examples, the workpiece flow modulating assembly 211 may include simple mechanical structure for modulating the flow of workpieces. For instance, the exemplary primary organization component assembly 207 shown in FIG. 2D, wherein like parts to the primary organization component assembly 207 shown in FIG. 2C are labeled with the same reference number, a stationary weir or partial barrier 240 is included in an opening of the hopper 234 of the workpiece receiving assembly 208. The weir 240 may be configured to alter flow characteristics of the workpieces through the hopper 234 to eliminate product jam or otherwise generally control the mass of workpieces flowing to a downstream component, such as the workpiece flow distribution assembly 212. In some examples, a stationary weir or partial barrier may instead or additionally be included in a hopper or chute downstream from the workpiece receiving assembly 208.

In some examples, the opening in the hopper of the workpiece receiving assembly 208 (e.g., hopper 234) may be an elongated shape extending substantially across a width of the workpiece flow path. For instance, the hopper opening may have a width that is substantially equal to or slightly less than a width of a downstream component (e.g., the workpiece flow distribution assembly 212) or a conveyance system. The hopper opening, either alone or in combination with a weir, can alter the flow of workpieces and help distribute an aggregated supply of workpieces across the width of the flow path.

In some examples, the workpiece flow modulating assembly 211 may be defined at least in part by cleats or other transverse protrusions extending across a belt of an elevated conveyor system. As described above, the bulk transfer subassembly 222 may be defined by an elevated endless conveyor system, which brings product upwardly with the conveyor belt as it rotates around rollers. The cleats on the belt can essentially act as a normalizing or modulating mechanism to control the amount of workpieces that travel upwardly with the belt and are dropped into the workpiece receiving assembly 208. Specifically, excess or doubled-up workpieces may result in an overall workpiece height greater than the height of the cleat. As such, the excess, doubled-up, or stacked workpieces may slide downwardly over the cleats and back into the hopper for redistribution onto the belt. In that regard, the bulk transfer subassembly 222 may again be considered a part of the workpiece flow modulating assembly 211, and vice versa.

In some examples, components of the workpiece flow modulating assembly 211 may be controllable by the primary organization controller 216 or another controller or computing device in communication therewith to modulate the workpiece mass flow through the primary organization assembly 122. For instance, the speed, frequency, etc., of the components of the workpiece flow modulating assembly 211 may be varied to precisely control the mass flow of workpieces into the workpiece receiving assembly 208 and/or downstream thereof.

Regarding the mass control of workpieces into the workpiece receiving assembly 208, one or more components of the workpiece supply assembly 218 may be controllable by the primary organization controller 216 or another controller to modulate the incoming flow. For instance, if the workpiece flow modulating assembly 211 includes an actuator for a vacuum pump or air compressor of the workpiece supply assembly 218, the actuator may be controlled to selectively allow the vacuum pump/compressor to move product between a hopper/tote of the workpiece supply assembly 218 and the workpiece receiving assembly 208 at a desired speed, batch frequency, etc. As another example, a motor or other drive system of an elevated endless conveyor system may be controlled to vary a speed of the conveyor belt to deposit a controlled amount of workpieces into the workpiece receiving assembly 208. In that regard, the workpiece flow modulating assembly 211 may incorporate components of the workpiece supply assembly 218.

In such examples of precise control of workpiece mass flow to the workpiece receiving assembly 208, a less sophisticated, non-controllable metering assembly may be used. For instance, a non-controllable workpiece flow metering assembly 210, such as a weir inside a hopper as shown in the system of FIG. 2D, may simply be used.

Regarding the mass control of workpieces out of the workpiece receiving assembly 208, one or more components of the workpiece receiving assembly 208 may be controllable by the primary organization controller 216 or another controller to modulate the outgoing flow. For instance, if the workpiece flow modulating assembly 211 includes an actuator-controlled hopper gate of the workpiece receiving assembly 208, the gate may be selectively opened at a desired speed, frequency, etc., to modulate the mass flow of workpieces out of the workpiece receiving assembly 208.

It can be appreciated from the foregoing that any suitable combination of metering and modulating devices, including components, systems, sensors and any controls, may be used to measure and/or control the mass flow of workpieces into and out of the workpiece receiving assembly 208. The desired or needed level of mass flow data gathering and/or control may be dependent on a variety of factors, including the number of workpiece processing changeovers occur through a shift, week, etc., the type of workpieces being processed, the processing type for the workpiece (e.g., portioning v. injection v. cooking v. freezing), and other factors.

In any event, the workpiece supply assembly 218, the workpiece receiving assembly 208, the workpiece flow metering assembly 210, and/or the workpiece flow modulating assembly 211 can be used to transition incoming, aggregated supplies of workpieces into a substantially continuous flow of workpieces. As described above, the workpieces are often supplied to the workpiece receiving assembly 208 in aggregated format, such as a bulk and/or batch format. For instance, a tote of workpieces may be elevated and dumped into a hopper of the workpiece receiving assembly 208. The workpiece receiving assembly 208, the workpiece flow metering assembly 210, and/or the workpiece flow modulating assembly 211 may cause an alternating batch process, supplied at a certain batch dump rate, to transform into a continuous workpiece flow. In that regard, a batch of workpieces can be caused to flow downstream from the workpiece receiving assembly 208 after a previous batch and before a subsequent batch substantially without an interruption in workpiece flow. In other words, course evenflow is substantially achieved.

When transitioning the aggregated or batched workpieces into a substantially continuous flow using the systems and methods described herein, the workpieces necessarily spread out across a width of a downstream component, such as across a belt of a conveyance system. In that regard, the workpiece supply assembly 218, the workpiece receiving assembly 208, the workpiece flow metering assembly 210, and/or the workpiece flow modulating assembly 211 can be considered to perform an initial organization or spreading of the workpieces for the primary organization assembly 122.

The substantially continuous flow of workpieces may flow to the workpiece flow distribution assembly 212 of the primary organization assembly 122. The workpiece flow distribution assembly 212 is generally configured to further organize the workpieces, regulate the flow, and/or create separation of the workpieces in the direction of flow. For instance, the workpiece flow distribution assembly 212 may include one or more mechanical separation devices configured to physically separate workpieces as they pass by the devices.

In some examples, the workpiece flow distribution assembly 212 may include a roller array having a plurality of powered rollers 244, each with a longitudinal axis extending substantially transversely to the direction of flow. For instance, the primary organization component assembly 207 shown in FIG. 2D includes five rollers 244. The same or similar arrangement of rollers may be used in the system shown in FIG. 2C. Each roller 244 may have a length along its axis that is substantially equal to a width of an opening in the workpiece receiving assembly 208 (such as an elongated hopper opening) and/or a width of a take-away conveyor system 248.

The rollers 244 may be arranged in series such that the workpieces pass over each of the rollers as they flow downstream. In some examples, the rollers 244 may also be staggered or arranged at an overall downward angle such that an upstream roller longitudinal axis is located higher or above a downstream roller longitudinal axis. In this manner, gravity can assist with movement of the workpieces over the series of rollers 244. An exterior surface defined on a body of each roller may include suitable texture, grooves, etc., to help grip and move the workpieces without damaging the workpieces.

Each roller 244 may rotate about its longitudinal axis, such as with an individual actuator or drive device. The rollers 244 may rotate at different speeds to facilitate separation of the workpieces and eliminate product jam as they flow downstream. For instance, an actuator or drive device of each roller 244 may rotate each downstream roller at a slightly faster speed than an adjacent, upstream roller. The difference in roller speed causes the workpieces to spread as they flow downstream. The workpiece flow distribution assembly 212 may incorporate the rollers and associated components used in the C.A.T. VacCAT Product Distribution System™, available from JBT Corporation of Chicago, IL.

In some examples, the workpiece flow distribution assembly 212 may include a take-away conveyor system 248 having one or more endless conveyors suitable to receive workpieces from the workpiece flow distribution assembly 212. The take-away conveyor system 248 can be configured to run at a speed suitable for conveying work pieces to the organization assessment assembly 124. For instance, the take-away conveyor system 248 can be configured to run at a faster speed(s) than the most downstream roller 244 for spreading out or otherwise adjusting the flow speed of workpieces

The take-away conveyor system 248 can also be configured to run at a speed suitable for spreading out or otherwise adjusting the flow speed of workpieces. In one example, one or more endless conveyors may be arranged in series, and the speed of each conveyor can be controllable to help spread the workpieces and/or to help modulate the flow speed. For instance, a first, upstream conveyor may move at a slightly slower speed than a second, adjacent, downstream conveyor, similar to the roller assembly to help spread the workpieces. Such a difference in speed can also slow the speed of flow without causing a disruption in flow and/or be used to correct disruption in flow. In other examples, if there is a gap in workpiece flow, the conveyor(s) speed may be increased to help close the flow gap. The take-away conveyor system 248 may be used in any other suitable manner to adjust or control the workpiece flow, such as to accommodate upstream workpiece supply or downstream processing requirements.

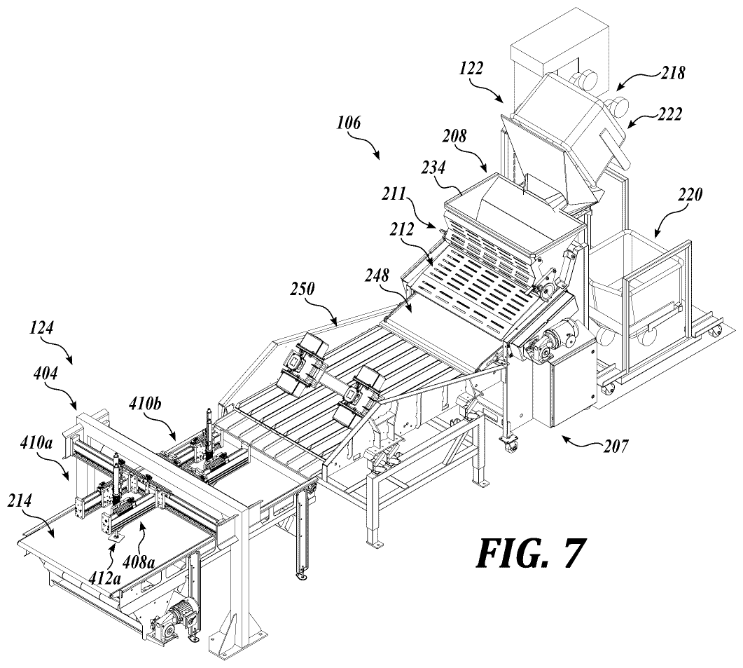

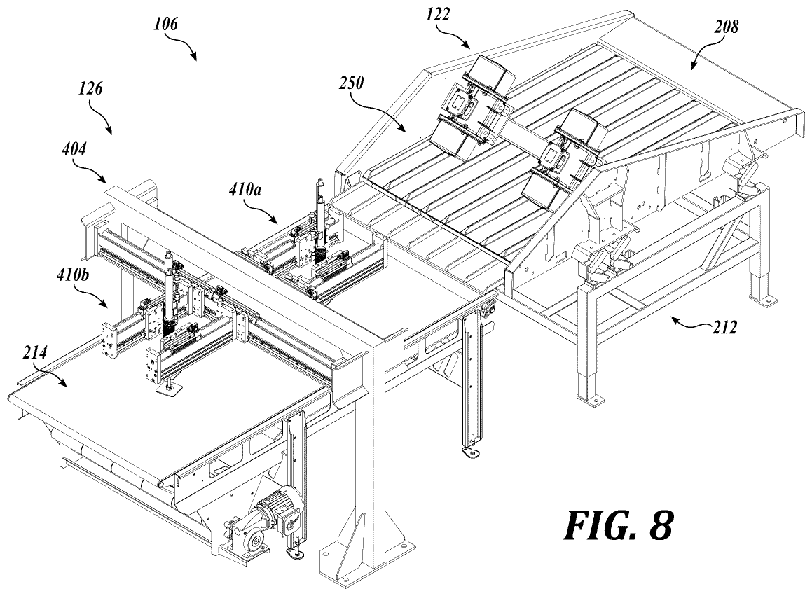

In some examples, the workpiece flow distribution assembly 212 may include a vibration assembly that helps facilitate workpiece movement and separation in the direction of flow. The vibration assembly may be associated with a conveyance system, a table, or the like that receives workpieces as they flow downstream. For instance, as shown in the exemplary automated infeed system 106 of FIGS. 7 and 8, a vibration assembly 250 can be configured as a shaker table that is in the path of workpiece flow. The vibration assembly 250 may be located downstream of the take-away conveyor system 248.

The vibration assembly may also or instead be configured to vibrate a conveyor belt of a conveyance system as the workpieces are conveyed downstream on the belt. For instance, the vibration assembly may be configured to vibrate a vibration conveyor located between the workpiece supply assembly 218 and/or a component of the primary organization component assembly 207.

Vibration of the vibration assembly can gently move or bounce the products, spreading them out as they move downstream. In some examples, the vibration assembly can incorporate lane dividers onto the conveyance system or the table that divide the conveyor or table into sections across its width, as shown in FIGS. 7 and 8. In that regard, the workpieces can be moved into lanes as they are separated by the vibrations. The lanes may substantially align with lanes of the take-away conveyor system 248, if used.

A vibration assembly may be used instead of or in addition to the rollers 244 of the workpiece flow distribution assembly 212. For instance, in the exemplary automated infeed system 106 shown in FIG. 7 (wherein the organization assessment assembly 124 is not shown), the vibration assembly 250 is located downstream of the rollers 244 of the workpiece flow distribution assembly 212. In this manner, the workpiece flow distribution assembly 212 and the vibration assembly 250 can together perform a very effective primary organization of the workpieces.

In some examples, the vibration assembly 250 may be used in place of other components of the primary organization component assembly 207. For instance, in the exemplary automated infeed system 106 shown in FIG. 8 (wherein the organization assessment assembly 124 is not shown, the workpiece flow metering assembly 210, and the workpiece flow modulating assembly 211 may be excluded. Instead, workpieces may be deposited directly onto the vibration assembly 250 from the workpiece supply assembly 218 (e.g., via a bin tipper), and the vibration assembly 250 performs all the necessary primary organization of the workpieces. In such an example, the vibration assembly 250 also defines the workpiece receiving assembly 208.

In some examples, the automated infeed system 106 may exclude the secondary organization assembly 126 if the primary organization assembly 122 is configured to perform all necessary organization of the workpieces for the workpiece processing system 104. For instance, if the primary organization assembly 122 is configured as a C.A.T. VacCAT Product Distribution System™ located upstream of a vibration assembly 250, such as that shown in FIG. 7, sufficient organization of the workpieces may be accomplished without the use of the secondary organization assembly 126.

In some examples, the workpiece flow distribution assembly 212 may include a scraper or kicker assembly configured to help minimize doubled-up or stacked workpieces. The kicker assembly may include suitable structure for scraping off or otherwise moving doubled-up or stacked workpieces back upstream for redistribution. For instance, a scraping device may extend transversely across a width of a conveyance system (such as the take-away conveyor system 248), and the scraping device may be at an optionally adjustable height such that it scrapes off or otherwise moves doubled-up or stacked workpieces back upstream for redistribution.

In some examples, the workpiece flow distribution assembly 212 may include one or more lane dividers configured to divide workpieces into lanes as they flow downstream. The lane dividers may be positioned generally along an axis of a conveyor belt, such as along a takeaway conveyor and/or along a conveyor of the take-away conveyor system 248. In some examples, the lane dividers may be incorporated into a vibration assembly, as discussed above and as shown in FIGS. 7 and 8. As the workpieces pass or are otherwise deposited onto the dividers, the workpieces separate into sections across the width of the belt. Such separation may help identify areas of focus or may help designate an area for one or more assessment components of the organization assessment assembly 124 and/or one or more organizing components of the secondary organization assembly 126. Such separation may also or instead support processing of the work pieces downstream.

In some examples, the workpiece flow distribution assembly 212 is excluded from the primary organization assembly 122, or its function is otherwise achieved by one or more other components of the primary organization assembly 122, such as the workpiece receiving assembly 208, the workpiece flow metering assembly 210, and the workpiece flow modulating assembly 211. For instance, if the workpiece receiving assembly 208, the workpiece flow metering assembly 210, and/or the workpiece flow modulating assembly 211 can sufficiently organize and spread the workpieces, the workpiece flow distribution assembly 212 may be eliminated in whole or in part.

Referring to FIGS. 2E and 2F, an alternate example of a primary organization assembly 122′ configured to carry out an initial organization of unorganized, aggregated workpieces will now be described. For ease of reference, parts similar to those described above with respect to the primary organization assembly 122 will be labeled with the same reference numeral except with a prime (′). In that regard, aspects described above with respect to the primary organization assembly 122 may apply to the primary organization assembly 122′. At the same time, it should be appreciated that aspects of the primary organization assembly 122′ are not limited to that described above with respect to the primary organization assembly 122.

In general, the primary organization assembly 122′ is configured to carry out an initial organization of unorganized, aggregated workpieces in a controllable, optimizable manner while increasing efficiencies of the assembly. In that regard, the primary organization assembly 122′ includes a primary organization component assembly 207′ having various subassemblies and components that can be controlled by a primary organization controller (such as primary organization controller 216 shown in FIG. 2A and/or other controllers or computing devices) to optimize metering, modulation, and distribution of unorganized, aggregated workpieces. At the same time, the subassemblies and components of the primary organization component assembly 207′ are arranged and configured to facilitate efficient loading, cleaning, and accommodation of space constraints, among other benefits.

The primary organization component assembly 207′, which includes one or more controllable components, subassemblies, or the like configured to carry out a primary organization of the workpieces, will now be described. Generally, the primary organization component assembly 207′ may include a workpiece receiving assembly 208′, a workpiece flow metering assembly 210′, a workpiece flow modulating assembly 211′, and a workpiece flow distribution assembly 212′. It should be appreciated that the various components described as being a part of the workpiece receiving assembly 208′, the workpiece flow metering assembly 210′, the workpiece flow modulating assembly 211′, and/or the workpiece flow distribution assembly 212′ may instead or additionally form a part of another assembly of the primary organization component assembly 207′. Thus, the descriptions should not be seen as limiting.

The workpiece receiving assembly 208′ will now be described. The workpiece receiving assembly 208′ is configured to selectively receive a supply of workpieces and controllably feed that supply to other components of the primary organization component assembly 207′, such as the workpiece flow metering assembly 210′, the workpiece flow modulating assembly 211′, and the workpiece flow distribution assembly 212′. In general, the workpiece receiving assembly 208′ includes a bulk supply receiving subassembly 209a′ configured to selectively receive a bulk supply of workpieces, and a buffering subassembly 209b′ configured to receive at least a portion of the bulk supply of workpieces deposited from the bulk supply receiving subassembly 209a′.

The bulk supply receiving subassembly 209a′ is configured to selectively and removably receive a bulk supply of workpieces, or a supply of workpieces in aggregated format, such as a large (bulk), predefined amount (batch) of workpieces in a tote, bin, hopper, or another suitable container. For instance, the bulk supply receiving subassembly 209a′ includes structure suitable for removably receiving a bulk container in a receiving position. In the example shown, the bulk supply of workpieces is a large tote T, and the bulk supply receiving subassembly 209a′ includes an opposing pair of guide rails or the like suitable for slidably receiving a tote therein. A suitable arrangement of side wall, bottom, and top support structures (e.g., framing elements) may extend between opposing pairs of guide rails and/or between the guide rails of each pair to temporarily secure the tote or other container within the bulk supply receiving subassembly 209a′. In some examples, the bulk supply receiving subassembly 209a′ includes tote receiving/supporting structure similar to the structure of the bulk transfer subassembly 222 described above with respect to FIG. 2B, such as the FTNON bin tipping system™ or the AHK lifting and tipping device™, both available from JBTMarel Corporation of Chicago, IL.

A bulk supply of workpieces may be supplied to the bulk supply receiving subassembly 209a′ in any suitable manner. For instance, the primary organization assembly 122′ may further include or may be configured to be associated with a workpiece supply assembly (not shown), such as an assembly having applicable features of the workpiece supply assembly 218. In that regard, the workpiece supply assembly may have an aggregated or bulk storage and/or an aggregated or bulk storage transfer assembly.

The bulk storage of the workpiece supply assembly may be a bulk container suitable for carrying/transporting a desired amount or weight of workpieces, such as a large tote T. In the example of food products being supplied to an industrial food processing machine, such as a portioner, the tote T may be, for instance, a 200-kg, a 1,000-kg, or a 2,000-pound tote (or heavier) of workpieces to be portioned, cut, trimmed, etc. It should be appreciated that any other suitable bulk storage container(s) may be used.

The bulk storage transfer assembly of the workpiece supply assembly may include a movement device configured to move the bulk storage from a first position to a second position. For instance, the bulk storage transfer assembly may include a lifting or elevation device suitable to elevate the bulk storage between a first height (e.g., ground height) and a second, raised height of the workpiece receiving assembly 208′. If the bulk storage is a large tote suitable for carrying a desired amount of workpieces (e.g., a 2,000-pound tote of single chicken breast fillets, such as tote T), the bulk storage transfer assembly may include a fork lift, an automated guided vehicle having a lifting structure, or another suitable lifting device, for lifting the tote T from a first height (e.g., ground height) to a receiving height of the bulk supply receiving subassembly 209a′.

In some examples, the bulk storage transfer assembly may include a bulk storage conveyance assembly having a first conveyor that moves the bulk storage between a first height (e.g., ground height) and a second, raised height of the workpiece receiving assembly 208′, and a second conveyor that moves the bulk storage between the second, raised height of the workpiece receiving assembly 208′ and the first height (e.g., ground height). A third conveyor or other assembly may be used to shift an emptied tote from the first conveyor to the second conveyor. Using such an assembly, loaded totes may be staged for substantially continuous delivery to the bulk supply receiving subassembly 209a′, minimizing delay between tote loading and unloading. Such a configuration may be useful for a high capacity workpiece processing system 104, such as an oven.

The bulk storage transfer assembly may include one or more sensors (e.g., positional sensors, weight measurement devices, image sensors, etc.) that are communicatively coupled to the primary organization controller 216 (and/or other controllers or computing devices). The primary organization controller 216 may output a control signal(s) in response to processed sensor data to activate one or more components or assemblies of the bulk storage transfer assembly to substantially continuously deliver bulk storage to the bulk supply receiving subassembly 209a′. For instance, if positional sensor data indicates that a tote is being moved toward a retracted, emptied position, the primary organization controller 216 may output a control signal(s) to a movement device configured to move into a position to receive an emptied tote and/or deposit a full tote to the bulk supply receiving subassembly 209a′ It should be appreciated that any suitable bulk storage transfer assembly and associated control methods may be used to optimize bulk storage loading and unloading.

Generally, the bulk supply receiving subassembly 209a′ has a receiving height that is substantially lower than a receiving height of a standard bulk supply receiving subassembly. For instance, the bulk supply receiving subassembly 209a′ has a receiving height that is substantially lower than the receiving height of the workpiece receiving assembly 208 shown in FIGS. 2C and 2D. In that regard, the primary organization assembly 122′ may have an overall height that is substantially lower than other primary organization assemblies, such as the primary organization assembly 122. An overall lower height facilitates, for instance, a more efficient bulk supply of workpieces (e.g., less time and energy consumed to lift a tote), easier maintenance and cleaning of the primary organization assembly, the ability to accommodate plant facilities having height restrictions, etc.

In any event, the bulk storage and/or the bulk storage transfer assembly described with respect to the workpiece receiving assembly 208′ may be considered a part of the primary organization assembly 122′ and/or they may be considered separate from the primary organization assembly 122′. In that regard, the primary organization assembly 122′ may be configured to receive an incoming bulk supply of workpieces in any suitable manner.

The bulk supply receiving subassembly 209a′ is operably and/or communicatively coupled to a portion of the workpiece flow metering assembly 210′ and the workpiece flow modulating assembly 211′ to controllably feed at least a portion of the bulk supply of workpieces from the tote T (or other suitable container) to the buffering subassembly 209b′. Exemplary aspects of the workpiece flow modulating assembly 211′ will first be described.

The workpiece flow modulating assembly 211′ may include a bulk supply deposit assembly configured to controllably deposit at least a portion of the bulk supply of workpieces from a bulk container (e.g., the tote T) to the buffering subassembly 209b′ of the workpiece receiving assembly. In the depicted example, the bulk supply deposit assembly is a controllable bin or tote tipper 213′ configured to controllably deposit at least a portion of the bulk supply of workpieces from the bulk container (e.g., tote T) to the buffering subassembly 209b′ located generally below and downstream of the tote tipper. In some aspects, at least some portions of the controllable bin or tote tipper 213′ (hereinafter simply “tote tipper 213′”) additionally or instead define the bulk storage transfer assembly configured to move the bulk storage (e.g., the tote T) from a first position to a second position.

In the example depicted, the tote tipper 213′ includes controllable mechanical and electrical structures suitable for moving a tote T between a receiving position and at least one dumping position. In a receiving position, the tote T is oriented substantially horizontally with a top opening facing upwardly and may be generally considered a zero degree (0°) position. In a dumping position, the tote T is oriented rotationally from the receiving position with the top opening of the tote generally facing towards the buffering subassembly 209b′. The tote tipper 213′ may move the tote T into one of several dumping positions rotationally displaced from the receiving position to facilitate a controlled amount of workpiece dumping into the buffering subassembly 209b′. For instance, the tote T may be moved to a dumping position in a range between about forty-five degrees (45°) and one hundred eighty degrees (180°) from the zero degree (0°) receiving position.

It can be appreciated that by moving the tote T rotationally towards a higher degree dumping position, such as one hundred forty-five degrees (145°), a substantially large mass of the bulk supply of workpieces will flow from the tote T into the buffering subassembly 209b′ at a substantially fast rate compared to the mass and flow rate of the bulk supply of workpieces with the tote T at a lower degree dumping position, such as sixty degrees (60°). As will be discussed further below, movement of the tote tipper 213′ may be controlled (e.g., by the primary organization controller 216) to vary the mass and flow rate of the bulk supply of workpieces based on various inputs, such as sensor data, processing requirements, etc. The bulk supply receiving subassembly 209a′ may include suitable structure for retaining the tote T therein as the tote T is moved between the various positions.

The tote tipper 213′ may have any suitable configuration for controllably moving the tote T via the bulk supply receiving subassembly 209a′ between a receiving position and at least one dumping position. For instance, the tote tipper 213′ may include mechanical and/or electrical structures similar to the bin tipping assembly described above with respect to FIG. 2B (e.g., the FTNON bin tipping system™ or the AHK lifting and tipping device™, both available from JBTMarel Corporation of Chicago, IL).

In the example shown, the tote tipper 213′ generally includes a U-shaped frame 215′ that supports a linkage assembly 217′ configured to move the bulk supply receiving subassembly 209a′ between a receiving position and at least one dumping position. A suitable actuator assembly 219′, such as an electric motor assembly, may be operably and mechanically coupled to the linkage assembly 217′ to power movement of the linkage assembly. The tote tipper 213′ may further include a positional encoder, such as an optical rotary encoder, to detect the rotational position of the tote T. The actuator assembly 219′ may be activated (e.g., in response to a signal received from the primary organization controller 216) to vary the mass and flow rate of the bulk supply of workpieces based on various inputs, such as sensor data, processing requirements, etc., as well as the rotational position and rotational speed (e.g., radians/second) of the tote T.

The workpiece flow metering assembly 210′, which is generally configured to meter a mass flow of the bulk supply of workpieces through the primary organization assembly 122′, will now be described. Generally, the workpiece flow metering assembly 210′ may include one or more sensors that can be used to determine a weight, volume, quantity, or other metric for metering the mass flow of workpieces through the primary organization assembly 122′. In that regard, the workpiece flow metering assembly 210′ may include or may be associated with one or more controllers (such as the primary organization controller 216) and/or computing devices for processing the sensor data and determining the workpieces mass flow metric(s).

The one or more sensors and/or controllers may be configured to meter or track the mass flow of workpieces within the tote T and/or leaving the tote T. For instance, the workpiece flow metering assembly 210′ may include a weight measurement sensor(s), such as a strain gauge, a load cell, etc., associated with the bulk supply receiving subassembly 209a′ to obtain a weight of the tote T. In that regard, the bulk supply receiving subassembly 209a′ may be mounted via a load cell to the u-shaped frame 215′ of the tote tipper 213′. The load cell may be configured to determine a weight of the tote T when in a receiving position and/or when in a dumping position.

One or more weight measurement sensors may be used to measure a weight of the tote T at defined increments of time, and a position (e.g., rotary) encoder may be used to determine a position of the tote T, the bulk supply receiving subassembly 209a′, etc. The corresponding weight and position measurements may be used to approximate the mass flow of workpieces into the buffering subassembly 209b′. For instance, based on historical data for a certain type of workpiece (e.g., chicken breast fillets that flow from a tote at a specific position), the mass flow of workpieces may be approximated.

In addition or in the alternative, the workpiece flow metering assembly 210′ may include one or more image sensors configured to obtain image sensor data of workpieces within the tote T and/or flowing out of the tote T and/or workpieces within a portion of the buffering subassembly 209b′. For instance, the workpiece flow metering assembly 210′ may include a first image sensor(s) 210a′ positioned to obtain image data of workpieces on a conveyance assembly of the buffering subassembly 209b′ (e.g., a primary organization assembly conveyor 223′). The image sensor(s) may be one or more of a structured light scanner, a video camera, a still optical camera, a stereo camera, etc., mounted relative to the tote T and/or the buffering subassembly 209b′ for capturing corresponding image data of workpieces. As noted above, the scanners used in the systems and methods described herein exclude any type of scanning that could be done by human observation, which would not support the needed processing speed and accuracy of the primary organization assembly 122′.

In addition or in the alternative, a weight measurement sensor may be associated with the buffering subassembly 209b′ to periodically and/or continuously obtain a weight of the buffering subassembly 209b′. Using weight data and/or image data, a controller such as the primary organization controller 216 or another computing device in communication therewith can determine mass data of workpieces in the tote T, mass data of workpieces flowing from the tote T at various dumping positions, and/or mass data of workpieces in the buffering subassembly 209b′. The image sensor data may be used to determine mass flow by determining a volume of workpieces.

Sensor data of the workpiece flow metering assembly 210′ may be sent to the primary organization controller 216 and/or computing devices in communication therewith for processing and/or controlling components of the primary organization assembly 122′ and/or the automated line loading management system 102. For instance, the mass data of workpieces can be processed to control aspects of the tote tipper 213′ for supplying a desired mass flow of workpieces to the buffering subassembly 209b′.

For instance, if an actual volume or weight of a mass of workpieces in the buffering subassembly 209b′ is different than an expected or necessary volume or weight, the primary organization controller 216 may output a signal(s) to a controller of the tote tipper 213′ indicative of the actual volume or weight of the workpieces so that a dumping rate of the workpieces may be adjusted as needed. For instance, if the primary organization controller 216 has data stored thereon indicating an expected/necessary mass flow of workpieces, the controller may output a signal to the actuator assembly 219′ of the tote tipper 213′ to provide more or less workpieces to the buffering subassembly 209b′ based on an actual mass of the workpieces in the buffering subassembly 209b′. Further, if the primary organization controller 216 has data stored thereon indicating a preferred mass flow of workpieces needed to meet downstream infeed requirements, the primary organization controller 216 may output a signal(s) to the actuator assembly 219′ of the tote tipper 213′ to provide more or less workpieces to the buffering subassembly 209b′ accordingly. A mass flow of workpieces may be adjusted or modulated, for instance, to accommodate workpiece processing infeed requirements to meet target throughput. In that regard, seeing as the tote tipper 213′ can be used to modulate workpiece mass flow, the tote tipper 213′ may be considered a portion of the flow modulating assembly 211′.

Further exemplary aspects of the workpiece flow modulating assembly 211′ for adjusting or modulating a mass flow of workpieces within the primary organization assembly 122′ will now be described. In general, the workpiece flow modulating assembly 211′ may include one or more mechanisms or features that can be used to alter a mass flow of workpieces within the primary organization assembly 122′. In the depicted example, the workpiece flow modulating assembly 211′ may be defined at least in part by the tote tipper 213′, the buffering subassembly 209b′, and a first thickness control subsystem 236′.

As noted above, the tote tipper 213′ may be controlled to provide more or less workpieces to the buffering subassembly 209b′, such as based on an actual mass of the workpieces in the buffering subassembly 209b′ compared to an expected/necessary mass, downstream infeed requirements, etc. Specifically, the actuator assembly 219′ of the tote tipper 213′ may be controlled to increase or decrease the dumping rotational position and/or the speed at which the tote T is moved between dumping rotational positions (both toward and away from the buffering subassembly 209b′).

The buffering subassembly 209b′ may be generally configured to supply a modulated mass of workpieces delved from the tote tipper 213′ to downstream portions of the primary organization assembly 122′. In the depicted example, the buffering subassembly 209b′ is defined by a horizontally oriented hopper 221′ having an open top and bottom. The open top of the horizontally oriented hopper 221′ is in workpiece flow communication with the open end of the tote T when the tote is in a dumping position. The open bottom of the horizontally oriented hopper 221′ is in communication with a primary organization assembly conveyor 223′. As workpieces are deposited into the horizontally oriented hopper 221′ from the tote T, the workpieces are conveyed from an upstream end toward a downstream end of the hopper by the primary organization assembly conveyor 223′. The primary organization assembly conveyor 223′ may be adjustable and/or controllable in speed to accommodate workpiece flow through the buffering subassembly 209b′.

The primary organization assembly conveyor 223′ may also be perforated to enable liquids that were dumped from the tote T to pass therethrough. In many situations, workpieces in bulk storage purge liquids during their storage time, such as brine and water. Moreover, the workpieces may be stored with ice to preserve freshness. In such an example, the primary organization component assembly 207′ may include spray bars above the tote tipper 213′ to help wash away the ice after dumping.

In any event, a large amount of liquid can be dumped from the tote T in addition to the workpieces. Such liquid is typically unaccounted for in mass flow estimations. If the liquid is collected and weighed, it can be accounted for in mass flow estimations. Thus, in the example of using a perforated primary organization assembly conveyor 223′, the buffering subassembly 209b′ may also include a catch tray that funnels the liquid into a bin with a load cell for weighing the liquid. The liquid weight can then be used to account for mass change estimation differences between the storage tote and the workpiece processing throughput. Any suitable assembly may be used to estimate the weight of the liquid.

Once deposited onto the primary organization assembly conveyor 223′, the workpieces are moved from an upstream end of the horizontally oriented hopper 221′ to a downstream end of the hopper. The downstream end of the horizontally oriented hopper 221′ may be narrower in width than the upstream end of the hopper, as shown. The narrowed, downstream end of the horizontally oriented hopper 221′ can thus constrict the flow of workpieces as they move through the hopper. In effect, the horizontally oriented hopper 221′ of the buffering subassembly 209b′ buffers or modulates the mass flowing downstream.

The mass flow of workpieces may be further controlled/constricted by one or more additional modulating devices, such as the first thickness control subsystem 236′. The first thickness control subsystem 236′ may be configured to help minimize doubled-up or stacked workpieces. In that regard, the first thickness control subsystem 236′ may be configured as a scraper or kicker assembly. The first thickness control subsystem 236′ may include suitable structure for scraping off (e.g., substantially prevent the workpieces from moving downstream with a conveyor) or otherwise moving doubled-up or stacked workpieces back upstream for redistribution. For instance, a scraping device may extend transversely across a width of a conveyance system (such as the primary organization assembly conveyor 223′), and the scraping device may be at an optionally adjustable height such that it scrapes off or otherwise moves doubled-up or stacked workpieces back upstream for redistribution.

In the depicted example, the first thickness control subsystem 236′ includes a first, fixed weir 240′ and a second, adjustable weir 242′. The fixed weir 240′ may be configured to alter flow characteristics of the workpieces through the horizontally oriented hopper 221′ of the buffering subassembly 209b′ to eliminate product jam or otherwise generally control the mass of workpieces flowing to a downstream component, such as the workpiece flow distribution assembly 212′.

The fixed weir 240′ may be configured as a gate extending substantially horizontally across the primary organization assembly conveyor 223′ between sidewalls of the narrowed portion of the horizontally oriented hopper 221′. A gap is defined between the gate and the top surface of the primary organization assembly conveyor 223′ such that workpieces must fit within the gap to flow downstream. In that regard, the gap may be of a predetermined size or height to target a certain mass flow of workpieces, to substantially reduce stacking of workpieces, etc.

The second, adjustable weir 242′ may be located downstream of the first, fixed weir 240′ to further control/constrict the mass flow of workpieces, but in an adjustable and/or controllable manner. The fixed weir 240′ may be configured to adjustably alter flow characteristics of the workpieces through the horizontally oriented hopper 221′ of the buffering subassembly 209b′ to eliminate product jam or otherwise generally control the mass of workpieces flowing to a downstream component, such as the workpiece flow distribution assembly 212′.

The adjustable weir 242′ may similarly be configured as a gate extending substantially horizontally across the primary organization assembly conveyor 223′ between sidewalls of the narrowed portion of the horizontally oriented hopper 221′, downstream of the fixed weir 240′. However, the gate of the adjustable weir 242′ may be adjustable in its position relative to the primary organization assembly conveyor 223′ to define a gap therebetween that is adjustable in size or height. For instance, the gate of the adjustable weir 242′ may be slidably received within vertical guides, and a gate actuator operably and mechanically coupled to the gate may be activated to move the gate vertically within the guides. As the gate is moved upwardly, the gap of the fixed weir 240′ increases, and as the gate is moved downwardly, the gap of the fixed weir 240′ decreases. By increasing or decreasing the gap size, the mass flow of workpieces may be correspondingly increased or decreased.

The gap of the adjustable weir 242′ may be adjusted in response to one or more control signal(s) received from a controller, such as the primary organization controller 216, and/or computing devices in communication therewith. In some examples, the primary organization controller 216 may output a signal(s) to the gate actuator of the adjustable weir 242′ to raise or lower the gate based on a height or thickness of the mass of workpieces flowing from the first, fixed weir 240′. In that regard, the workpiece flow metering assembly 210′ may include a second image sensor 210b′ located downstream of the first image sensor 210a′ and positioned to obtain image data of workpieces flowing through the fixed weir 240′ downstream toward the adjustable weir 242′. The second image sensor 210b′ may be one or more of a structured light scanner, a video camera, a still optical camera, a stereo camera, etc., mounted relative to the primary organization assembly conveyor 223′ between the weirs 240′ and 242′ for capturing corresponding image data of workpieces.

As noted above, the tote tipper 213′ may be controlled to provide more or less workpieces to the buffering subassembly 209b′, such as based on an actual mass of the workpieces in the buffering subassembly 209b′ compared to an expected/necessary mass, downstream infeed requirements, etc. Specifically, the actuator assembly 219′ of the tote tipper 213′ may be controlled to increase or decrease the dumping rotational position and/or the speed at which the tote T is moved between dumping rotational positions (both toward and away from the buffering subassembly 209b′).

In some examples, the primary organization controller 216 may output a signal(s) to the actuator of the tote tipper 213′ to adjust or modulate a mass flow of workpieces based on one or more of an actual or calculated mass of workpieces in the buffering subassembly 209b′, and/or an actual or calculated mass of workpieces flowing through the first, fixed weir 240′.

In addition or in the alternative, a weight measurement sensor may be associated with the primary organization assembly conveyor 223′ to periodically and/or continuously obtain a weight of the workpieces between the weirs 240′ and 242′. Using the weight data and/or the image data, a controller such as the primary organization controller 216 or another computing device in communication therewith can determine mass data of workpieces on the primary organization assembly conveyor 223′ between the weirs 240′ and 242′.

Sensor data of the second image sensor 210b′ and/or any weight measurement sensor may be sent to the primary organization controller 216 and/or computing devices in communication therewith for processing and/or controlling components of the primary organization assembly 122′ and/or the automated line loading management system 102. The mass data of workpieces flowing between the weirs 240′ and 242′ can be processed to control the tote tipper 213′ to adjust or modulate a mass flow of workpieces.

For instance, if the primary organization controller 216 has data stored thereon indicating a preferred mass flow of workpieces needed to meet downstream infeed requirements, the primary organization controller 216 may output a signal(s) to the actuator of the tote tipper 213′ to adjust its dumping profile to adjust a mass flow of the workpieces accordingly. A mass flow of workpieces may be adjusted or modulated, for instance, to accommodate workpiece processing infeed requirements to meet target throughput. Any other suitable normalizing or modulating mechanism may instead or additionally be used to control mass flow of workpieces downstream.

In some examples, the workpiece flow modulating assembly 211′ may be defined at least in part by the workpiece supply assembly. As described above, a bulk storage transfer assembly of the workpiece supply assembly may include a movement device configured to move the bulk storage from a first position to a second position. For instance, the bulk storage transfer assembly may include a lifting or elevation device suitable to elevate bulk storage (such as tote T) between a first height (e.g., ground height) and a second, receiving height of the bulk supply receiving subassembly 209a′ of the workpiece receiving assembly 208′. In some examples, the bulk storage transfer assembly may include a conveyance assembly for conveying bulk storage devices (such as tote T) to the bulk supply receiving subassembly 209a′.

The rate and frequency at which the bulk storage is supplied to the bulk supply receiving subassembly 209a′ can, at least in part, normalize or modulate the workpiece mass flow. In that regard, one or more components of the workpiece supply assembly may be controllable by the primary organization controller 216 or another controller/computing device to modulate the incoming flow. For instance, if the workpiece supply assembly includes an automated guided vehicle (AGV) system, the primary organization controller 216 or another controller/computing device may output signals to a controller/computing device of the AGV system to control the rate at which a bulk storage (such as tote T) is delivered to the bulk supply receiving subassembly 209a′. In that regard, the workpiece supply assembly may be considered a part of the workpiece flow modulating assembly 211′, and vice versa.

It can be appreciated from the foregoing that any suitable combination of metering and modulating devices, including components, systems, sensors and any controls, may be used to measure and/or control the mass flow of workpieces into and out of the workpiece receiving assembly 208′. The desired or needed level of mass flow data gathering and/or control may be dependent on a variety of factors, including the number of workpiece processing changeovers occur through a shift, week, etc., the type of workpieces being processed, the processing type for the workpiece (e.g., portioning v. injection v. cooking v. freezing), and other factors.

In any event, the workpiece supply assembly, the workpiece receiving assembly 208′, the workpiece flow metering assembly 210′, and/or the workpiece flow modulating assembly 211′ can be used to transition incoming, aggregated supplies of workpieces into a substantially continuous flow of workpieces. As described above, the workpieces are supplied to the workpiece receiving assembly 208′ in aggregated format, such as a bulk and/or batch format (e.g., a tote of workpieces). The workpiece receiving assembly, the workpiece flow metering assembly 210′, and/or the workpiece flow modulating assembly 211′ may cause an alternating batch process, supplied at a certain batch dump rate, to transform into a continuous workpiece flow. In that regard, a batch of workpieces can be caused to flow downstream from the workpiece receiving assembly 208′ after a previous batch and before a subsequent batch substantially without an interruption in workpiece flow. In other words, course evenflow may be substantially achieved.

When transitioning the aggregated or batched workpieces into a substantially continuous flow using the systems and methods described herein, the workpieces necessarily spread out across a width of a downstream component, such as across a belt of a conveyance system. In that regard, the workpiece supply assembly, the workpiece receiving assembly 208′, the workpiece flow metering assembly 210′, and/or the workpiece flow modulating assembly 211′ can be considered to perform an initial organization or spreading of the workpieces for the primary organization assembly 122′.

The substantially continuous flow of workpieces may flow to the workpiece flow distribution assembly 212′ of the primary organization assembly 122′. The workpiece flow distribution assembly 212′ is generally configured to further organize the workpieces, regulate the flow, and/or create separation of the workpieces in the direction of flow. For instance, the workpiece flow distribution assembly 212′ may include one or more mechanical separation devices configured to physically separate workpieces as they pass by the devices.

In some examples, the workpiece flow distribution assembly 212′ may include a roller array defined by a plurality of powered rollers 244′ each having a longitudinal axis extending substantially transversely to the direction of flow. For instance, the primary organization component assembly 207′ shown in FIGS. 2E and 2F includes eight rollers 244′. Each roller 244′ may have a length along its axis that is substantially equal to a width of the narrowed portion of the horizontally oriented hopper 221′ of the buffering subassembly 209b′ and/or a width of the primary organization assembly conveyor 223′ and/or a width of a take-away conveyor system 248′.

The rollers 244′ may be arranged in series such that the workpieces pass over each of the rollers as they flow downstream. An exterior surface defined on a body of each roller may include suitable texture, grooves, etc., to help grip and move the workpieces without damaging the workpieces.

Each roller 244′ may rotate about its longitudinal axis, such as with an individual actuator or drive device. The rollers 244′ may rotate at different speeds to facilitate separation of the workpieces and eliminate product jam as they flow downstream. For instance, an actuator or drive device of each roller 244′ may rotate each downstream roller at a slightly faster speed than an adjacent, upstream roller. The difference in roller speed causes the workpieces to spread as they flow downstream. The workpiece flow distribution assembly 212′ may incorporate the rollers and associated components used in the C.A.T. VacCAT Product Distribution System™, available from JBT Corporation of Chicago, IL.

In some examples, one or more of the rollers 244′ may have a plurality of selective traction or workpiece separating features to help facilitate separation of workpieces as they are moved downstream by the rollers. For instance, each roller 244′ may have a plurality of grooves extending substantially transversely to the longitudinal axis of the roller. The grooves may be of substantially the same size (e.g., width) and shape across all the rollers 244′, or the size and/or shape may vary across the rollers. For instance, the grooves may widen or change shape from the upstream roller to the downstream roller to gradually separate the workpieces as they are moved downstream by the rollers 244′. A plurality of guide spaced fins may also or instead extend transversely along the rollers to help facilitate separation of workpieces as they are moved downstream by the rollers.

Workpiece separating features may be used with certain types of workpieces that tend to stick together, such as due to the stiffness of the workpieces, due to coatings on the workpieces, etc. For instance, poultry tenders may stick together without the use selective traction or workpiece separating features used on the rollers 244′.

In some examples, the workpiece flow distribution assembly 212′ may include a second thickness control subsystem 246′ at the end of the roller array 244′. The second thickness control subsystem 246′ may be generally configured to help minimize doubled-up or stacked workpieces. In some examples, the second thickness control subsystem 246′ is considered a part of the workpiece flow modulating assembly 211′.

Like the first thickness control subsystem 236′, the second thickness control subsystem 246′ includes suitable structure for scraping off or otherwise moving doubled-up or stacked workpieces back upstream for redistribution. For instance, the second thickness control subsystem 246′ may also be configured as a weir or partial barrier.

In the depicted example, the second thickness control subsystem 246′ is configured as a rotary device that kicks back upstream stacked workpieces, e.g., workpieces that are sitting on top of a base layer of workpieces that are disposed on the conveyor belt. The rotary device may be defined as a plurality of fins extending radially from a central, elongated roller or rod that extends across a width of the roller array. The fins may be spaced to appropriately engage a certain type or size of workpiece, and in that regard, the rotary device may be adjustable and/or interchangeable. The fins may be rigid or at least somewhat elastomeric in nature, depending on, for instance, the type of workpiece being organized.

The central, elongated roller or rod of the rotary device may be powered and controllable by a suitable actuator. In some examples, the rotary device is activated and controlled in response to control signals received by the primary organization controller 216. For instance, the rotary device may be activated and rotated at a certain speed when a certain thickness of layered workpieces is detected by a sensor(s), such as the second image sensor 210b′. In some examples, the rotary device is activated and run continuously during operation of the primary organization assembly 122′.

The workpiece flow distribution assembly 212′ may include a take-away conveyor system 248′ having one or more endless conveyors suitable to receive workpieces from the workpiece flow distribution assembly 212′. The take-away conveyor system 248′ may incorporate aspects described above with respect to the take-away conveyor system 248. In that regard, the take-away conveyor system 248′ can be configured to run at a speed suitable for conveying work pieces to the organization assessment assembly 124. Moreover, the take-away conveyor system 248′ can be configured to run at a faster speed(s) than the most downstream roller 244′ for spreading out or otherwise adjusting the flow speed of workpieces. In that regard, one or more endless conveyors may be arranged in series, and the speed of each conveyor can be controllable to help spread the workpieces and/or to help modulate the flow speed.

In some examples, the workpiece flow distribution assembly 212′ may include a vibration assembly that helps facilitate workpiece movement and separation in the direction of flow. The vibration assembly may be associated with a conveyance system, a table, or the like that receives workpieces as they flow downstream. For instance, the workpiece flow distribution assembly 212′ may incorporate a shaker table that is in the path of workpiece flow, such as like the vibration assembly 250 shown in FIGS. 7 and 8. The vibration assembly may also or instead be configured to vibrate a conveyor belt of a conveyance system as the workpieces are conveyed downstream on the belt. For instance, the vibration assembly may be configured to vibrate the primary organization assembly conveyor 223′ and/or the take-away conveyor system 248′.

Vibration of the vibration assembly can gently move or bounce the products, spreading them out as they move downstream. In some examples, the vibration assembly can incorporate lane dividers onto the conveyance system or the table that divide the conveyor or table into sections across its width, as shown in FIGS. 7 and 8. In that regard, the workpieces can be moved into lanes as they are separated by the vibrations. The lanes may substantially align with lanes of a workpiece flow conveyance assembly 214 of the secondary organization assembly 126, if lanes are used. A vibration assembly may be used instead of or in addition to the rollers 244′ of the workpiece flow distribution assembly 212′.

In some examples, the workpiece flow distribution assembly 212′ may include one or more lane dividers configured to divide workpieces into lanes as they flow downstream. The lane dividers may be positioned generally along an axis of a conveyor belt, such as along a takeaway conveyor of the take-away conveyor system 248′. In some examples, the lane dividers may be incorporated into a vibration assembly, as discussed above and as shown in FIGS. 7 and 8. As the workpieces pass or are otherwise deposited onto the dividers, the workpieces separate into sections across the width of the belt. Such separation may help identify areas of focus or may help designate an area for one or more assessment components of the organization assessment assembly 124 and/or one or more organizing components of the secondary organization assembly 126. Such separation may also or instead support processing of the work pieces downstream.

In some examples, the workpiece flow distribution assembly 212′ is excluded from the primary organization assembly 122′, or its function is otherwise achieved by one or more other components of the primary organization assembly 122′, such as the workpiece receiving assembly 208′, the workpiece flow metering assembly 210′, and the workpiece flow modulating assembly 211′. For instance, if the workpiece receiving assembly 208′, the workpiece flow metering assembly 210′, and/or the workpiece flow modulating assembly 211′ can sufficiently organize and spread the workpieces, the workpiece flow distribution assembly 212′ may be eliminated in whole or in part.

As noted above with respect to the primary organization assembly 122, in some examples, the automated infeed system 106 may exclude the secondary organization assembly 126 if the primary organization assembly 122′ is configured to perform all necessary organization of workpieces for the workpiece processing system 104. For instance, if the primary organization assembly 122′ is configured as shown in FIGS. 2E and 2F, secondary organization of the workpieces may be more efficiently accomplished with manual labor and without the use of the secondary organization assembly 126. In that regard, in some examples, and as will be described further with respect to FIG. 11, portions of the secondary organization assembly 126 may be removable to support line flexibility.

The primary organization controller 216 and/or one or more computing devices in communication therewith may be used to control one or more components, subassemblies, etc., of the primary organization component assembly 207′ to optimize primary organization of the workpieces. In general, the primary organization controller 216′ and/or one or more other computing devices may be used to control the primary organization component assembly 207′ in a suitable manner, such as with a PID loop, in response to output instructions from a machine learning model, etc., to maximize workpiece mass flow, workpiece position, workpiece orientation, workpiece spacing, workpiece arrangement, etc.

Workpieces may flow downstream from the primary organization assembly 122′ (e.g., specifically from the workpiece flow distribution assembly 212, the workpiece receiving assembly 208, the workpiece flow metering assembly 210, and/or the workpiece flow modulating assembly 211) to a workpiece flow conveyance assembly 214. The workpiece flow conveyance assembly 214 may be a movement assembly generally configured to move workpieces from the primary organization assembly 122 toward and/or through the organization assessment assembly 124. The workpiece flow conveyance assembly 214 may be configured as one or more endless conveyors having a conveyor belt wrapped around at least two rollers and driven by a drive source. The conveyor belt may have a width at least as great as a width of a take-away conveyor of the workpiece flow distribution assembly 212 or any other upstream component from which it receives product. An encoder may be employed with respect to a roller to determine a position of a workpiece on the conveyor belt.

The workpiece flow conveyance assembly 214 may move the workpieces to and/or through the organization assessment assembly 124, which is configured to assess the organization, spacing, orientation, etc., of the workpieces after passing through the primary organization assembly 122. In that regard, the workpiece flow conveyance assembly 214 may instead or additionally be considered a part of the organization assessment assembly 124.

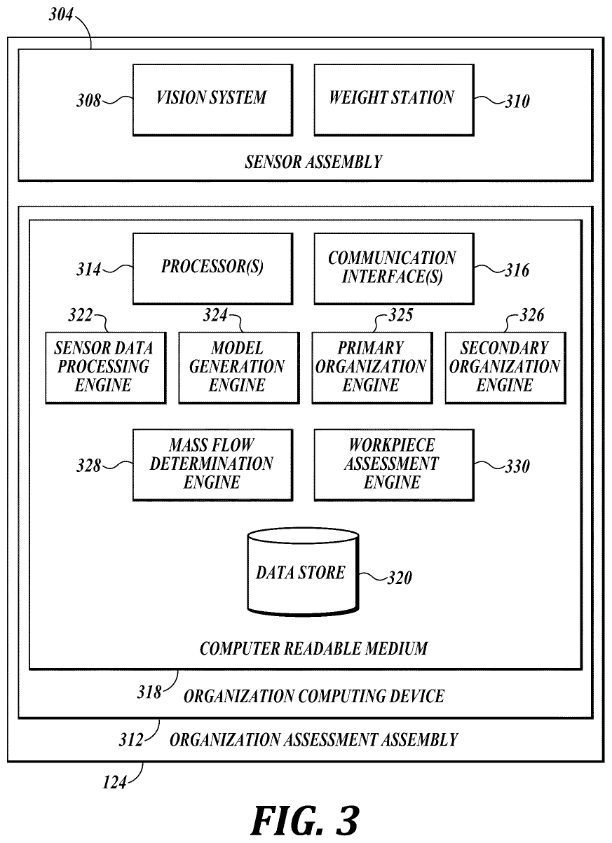

Referring to the exemplary block diagram shown in FIG. 3, the organization assessment assembly 124 may include a sensor assembly 304 having one or more sensors configured to capture data of the workpieces, preferably as they are moved by the workpiece flow conveyance assembly 214. In some examples, the sensor assembly 304 includes a vision system 308 configured to capture image sensor data and an optional weight station 310 configured to capture weight sensor data of the workpieces as they are moved by the workpiece flow conveyance assembly 214.

The vision system 308 may include any suitable image sensors configured to capture image data of the moving workpieces for assessing the organization, spacing, orientation, etc., of the workpieces. For instance, the vision system 308 may include an optical scanner for generating at least one of a visible light (e.g., greyscale) image, a laser light scattering image, a height map, a hyperspectral image, a multispectral image, etc., of the workpiece to show one or more of the overall shape/size of the workpiece, a height or thickness over the area of the workpiece, etc. Scanning with an optical scanner can be carried out using a variety of techniques, such as the techniques shown and described in U.S. patent Ser. No. 10/654,185, entitled “Cutting/portioning using combined X-ray and optical scanning”, as well as U.S. patent Ser. No. 10/721,947, entitled “Apparatus for acquiring and analysing product-specific data for products of the food processing industry as well as a system comprising such an apparatus and a method for processing products of the food processing industry,” incorporated herein by reference in their entirety.

The optical scanner may include a video camera to view a food product illuminated by one or more light sources. In one example, light from the light source is extended across the moving conveyor belt to define a sharp shadow or light stripe line, with the area forwardly of the transverse beam being dark. When no workpiece is being carried by the conveyor belt, the shadow line/light stripe forms a straight line across the belt. However, when a workpiece passes across the shadow line/light stripe, the upper, irregular surface of the workpiece produces an irregular shadow line/light stripe as viewed by a video camera directed diagonally downwardly on the workpiece and the shadow line/light stripe. The video camera detects the displacement of the shadow line/light stripe from the position it would occupy if no workpiece were present on the conveyor belt. This displacement represents the thickness of the workpiece along the shadow line/light stripe. The length of the workpiece is determined by the distance of the belt travel that shadow line/light stripes are created by the workpiece.

The conveyor belt of the workpiece flow conveyance assembly 214 may be a flat, solid (typically flat, non-metallic) belt to support the workpiece during scanning. Moreover, an encoder may be used to track belt movement for accurately capturing image data relative to sweep distance of the laser line. A scan area may be defined along a length and width of the belt for capturing relevant time-stamped workpiece scan data while excluding (e.g., blobbing out) any irrelevant workpiece scan data.

In some examples, the optical scanner is a single SICK® camera with a single laser light source that is suitable for capturing optical data and generating two or more images/views based on the optical data. The vision system 308 may also include image sensor technology suitable for capturing image data needed to generate 3D models of the workpieces and/or a 2D representation of the height or elevation of the scene. In some examples, the vision system 308 includes at least one of a 3D vision system or 3D laser scanning technology like LiDAR (Light Detection and Ranging), structured light scanning, or photogrammetry, or combinations thereof. In some examples, the vision system 308 includes a structured light source and scanner configured to capture workpiece depth and surface information for generating a height map or 3D model of the workpiece and/or a 2D representation of the height or elevation of the scene (sometimes also referred to herein as a “3D laser scanner” or the like).

In some examples, the sensor assembly 304 may also include a weight station 310 configured to capture a weight of the workpieces as they are moved by the workpiece flow conveyance assembly 214 through the organization assessment assembly 124. For instance, the workpiece flow conveyance assembly 214 may incorporate a weigh deck or another weight measurement device to capture a weight measurement of workpieces for a certain belt span length, at a certain time, etc. In some examples, the optional weight station 310 is used to estimate a weight measurement of workpieces by detecting a vertical displacement of the conveyor belt and associating that vertical displacement with a weight. For instance, the conveyor belt may sag under the weight of the workpieces, and the sag of the belt captured in image data can be measured. In some examples, the workpiece flow conveyance assembly 214 can be supported on high precision springs that allow vertical displacement of the workpiece flow conveyance assembly 214 for measurement.

The sensor assembly 304 may also include any other suitable sensors for capturing data pertaining to the workpieces. For instance, the sensor assembly 304 may also include one or more of a temperature sensor (e.g., thermal imaging cameras, infrared thermometers, thermocouples, resistance thermometers such as Resistance Temperature Detectors (RTDs), a stereo and color camera, such as for capturing still images (e.g., Intel RealSense D405), microphones, an optical encoder assembly, etc. As noted above, any scanners used in the systems and methods described herein exclude any type of scanning that could be done by human observation, which would not support the needed processing speed and accuracy of the automated infeed system 106 or the automated line loading management system 102.

In some examples, such as shown in the exemplary automated line loading management system 102′ of FIG. 11, a sensor assembly 304 may be a standalone, readily deployable unit that can be positioned where needed relative to the workpiece flow conveyance assembly 214, replaced when needed, etc. For instance, in some examples the sensor assembly 304 is configured as a pedestal image sensor assembly or vision system 308′ having a touchless encoder (e.g., a digital optical encoder) to determine belt speed and position and a structured light source and scanner configured to capture workpiece depth and surface information. Such a standalone vision system sensor 308′ may include an on-board data processor and/or be in communication with a separate computing device.

For instance, sensor data captured by the sensor assembly 308′, as well as any sensor data of the primary organization assembly 122′, may be transmitted to an organization computing device 312 of the organization assessment assembly 124 or another computing device associated therewith, such as the data processing computing device 108. In the exemplary block diagram of FIG. 3, the organization computing device 312 includes a processor(s) 314, a communication interface(s) 316, computer readable medium 318, and at least one data store 320. As shown, the computer readable medium 318 has stored thereon logic that, in response to execution by the one or more processor(s) 314, may cause the organization computing device 312 to provide a sensor data processing engine 322, a model generation engine 324, a primary organization engine 325, a secondary organization engine 326, a mass flow determination engine 328, and a workpiece assessment generation engine 330.

The organization computing device 312 may be implemented by any computing device or collection of computing devices, including but not limited to a desktop computing device, a laptop computing device, a mobile computing device, a server computing device, a computing device of a cloud computing system, and/or combinations thereof. In some examples, the processor(s) 314 may include any suitable type of general-purpose computer processor. In some examples, the processor(s) 314 may include one or more special-purpose computer processors or AI accelerators optimized for specific computing tasks, including but not limited to graphical processing units (GPUs), vision processing units (VPTs), and tensor processing units (TPUs).

In some examples, the computer readable medium 318 includes one or more hardware and or software interfaces suitable for providing communication links between components. The communication interface(s) 316 may support one or more wired communication technologies (including but not limited to Ethernet, FireWire, and USB), one or more wireless communication technologies (including but not limited to Wi-Fi, WiMAX, Bluetooth, 2G, 3G, 4G, 5G, and LTE), and/or combinations thereof.

As used herein, “computer-readable medium” refers to a removable or nonremovable device that implements any technology capable of storing information in a volatile or non-volatile manner to be read by a processor of a computing device, including but not limited to: a hard drive; a flash memory; a solid state drive; random-access memory (RAM); read-only memory (ROM); a CD-ROM, a DVD, or other disk storage; a magnetic cassette; a magnetic tape; and a magnetic disk storage.

As used herein, “engine” refers to logic embodied in hardware or software instructions, which can be written in one or more programming languages, including but not limited to C, C++, C#, COBOL, JAVA™, PUP, Perl, HTML, CSS, JavaScript, VBScript, ASPX, Go, and Python. An engine may be compiled into executable programs or written in interpreted programming languages. Software engines may be callable from other engines or from themselves. Generally, the engines described herein refer to logical modules that can be merged with other engines or can be divided into sub-engines. The engines can be implemented by logic stored in any type of computer-readable medium or computer storage device and be stored on and executed by one or more general purpose computers, thus creating a special purpose computer configured to provide the engine or the functionality thereof. The engines can be implemented by logic programmed into an application-specific integrated circuit (ASIC), a field-programmable gate array (FPGA), or another hardware device.

As used herein, “data store” refers to any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, such as a hard disk drive, a flash memory, RAM, ROM, or any other type of computer-readable storage medium. One of ordinary skill in the art will recognize that separate data stores described herein may be combined into a single data store, and/or a single data store described herein may be separated into multiple data stores, without departing from the scope of the present disclosure.

The sensor data processing engine 322 of the organization computing device 312 may be configured to receive sensor data for workpieces and send that sensor data (after any pre-processing) to another component of the organization computing device 312 and/or to another computing device, such as the data processing computing device 108, the model management computing device 107, and/or the processor computing device 120. The sensor data may include one or more images captured by the sensor assembly 304 (or 304′), sensor data of the primary organization assembly 122′ (e.g., one or more images captured by the image sensor(s) 210a′ and 210b′, weight data, etc.), etc. For instance, the sensor data may include one or more images generated by an optical scanner.

The sensor data processing engine 322 may perform any necessary pre-processing before sending the sensor data to another component of the organization computing device 312 and/or another computing device. Pre-processing may include generating views from image data (e.g., using one or more feature recognition modules), formatting image data and/or views generated from image data, packaging/condensing/transposing data for transmitting to the data processing computing device 108, etc. For instance, one or more of the imaging and/or calibrating methods described in U.S. Pat. Nos. 8,839,949, 10,471,619, 10,654,185, 10,721,947, 11,475,977, 10,427,882, 10,869,489, 11,266,156, incorporated by reference in their entirety, may be used for pre-processing. Processed/formatted sensor data may be saved to the at least one data store 320, sent to another engine of the organization computing device 312, and/or sent to another computing device, such as the data processing computing device 108, the model management computing device 107, and/or the processor computing device 120.

In some examples, the sensor data processing engine 322 may include one or more formatting modules configured to format the sensor data for optimal transport to and/or processing by the data processing computing device 108, the model management computing device 107, or another computing device. For instance, formatting modules of the sensor data processing engine 322 may perform at least one of transforming the sensor data, re-sizing the sensor data, labeling the sensor data, augmenting the sensor data, etc. In the specific example of an image, formatting modules may perform at least one of gray-scaling the image, translating the image, rotating the image, scaling/re-sizing the image, adjusting contrast of the image, changing the contrast of the image data, adapting the image to certain model constraints, etc. Any suitable image processing libraries (e.g., Python) available to the organization computing device 312 and/or the data processing computing device 108, the model management computing device 107, or any other computing device may be used to carry out pre-processing of image data.

In some aspects, the sensor data processing engine 322 sends sensor data to the at least one data store 320 and/or the model generation engine 324 of the organization computing device 312 for generating one or more of a 2D and 3D model of each of the scanned workpieces and/or a mass of workpieces. The model generation engine 324 may include software modules suitable for processing scan data and generating 3D models (showing contour, shape, volume, etc.), 2D models (e.g., showing a height and outline), or other images. For instance, the model generation engine 324 may run the proprietary DSI Q-LINK™ Portioning Software developed by Design Systems, Inc. of Redmond, Washington.

In some aspects, the sensor data and/or a 2D and 3D model of the scanned workpieces are used by the mass flow determination engine 328 of the organization computing device 312 for estimating a mass flow of workpieces through the organization assessment assembly 124. The mass flow of workpieces may be estimated by determining a piece count rate or belt load density for a length of conveyor belt and an estimated average volume of each of the workpieces. For instance, the mass flow determination engine 328 may incorporate aspects of the proprietary DSI Q-LINK™ Portioning Software referenced above for determining a mass flow of workpieces.

In some examples, the estimated mass flow determined by the mass flow determination engine 328 may be used to confirm and/or adjust a mass flow estimation of the primary organization assembly 122 or 122′, such as a mass flow estimation determined by using one or more sensors associated with the workpiece flow metering assembly 210 or 210′, the workpiece supply assembly 218, and/or the workpiece receiving assembly 208 or 210′. In some examples, the primary organization assembly 122 or 122′ does not meter or estimate mass flow, and the estimated mass flow of the mass flow determination engine 328 may be used.

For instance, if the primary organization assembly 122 or 122′ includes precise control of workpiece mass flow to the workpiece receiving assembly 208 or 208′, a less sophisticated, non-controllable metering assembly (such as a weir inside a hopper) may be used. In that regard, the estimated mass flow may instead be determined by the mass flow determination engine 328. In some examples, the estimated mass flow determined by the mass flow determination engine 328 may be confirmed and/or adjusted by the processor computing device 120 of the workpiece processing system 104, which receives workpiece sensor data from the workpiece sensor system 116 (e.g., a scanning system).

In some aspects, the sensor data and/or a 2D and 3D model(s) of the scanned workpieces is used by the workpiece assessment generation engine 330 of the organization computing device 312 for assessing one or more processing aspects of a workpiece. For instance, the workpiece assessment generation engine 330 may process the sensor data and/or a 2D and 3D model of the scanned workpiece to assess one or more of a size (such as volume, height, thickness, cross-sectional dimensions, etc.), shape, weight, density, temperature, texture, etc., of a workpiece to determine whether the workpiece is suitable for processing by the workpiece processing system 104.

If the workpiece processing system 104 is a thermal processing system, such as an oven, cook times may be tailored to a size and an incoming temperature of workpieces (in addition to other factors, such as workpiece spacing). Processors of chicken and other meats need to make sure that raw cut pieces supplied to their customers meet the customers' requirements for cook-time considerations, such as cross-sectional dimensions, etc. In the case of a poultry or pork piece, while it is expected that its surface, edges, and any thin spots will likely reach and exceed a required minimum temperature, typically 165 F.°, relatively quickly, the middle of its thickest part probably will not reach this temperature during the same time. If a raw cut piece supplied to a customer exceeds these cross-sectional dimensions, cook-time checks will fail and the piece will be rejected.

Thus, the workpiece assessment generation engine 330 may assess one or more processing aspects of a workpiece (e.g., size, temperature, etc.) to determine whether the workpiece is suitable for the workpiece processing system 104, or if the workpiece should instead be removed from the workflow or otherwise diverted to another area. If the workpiece assessment generation engine 330 determines that the workpiece is suitable for the workpiece processing system 104, it can be left on the workpiece flow conveyance assembly 214 for movement to the secondary organization assembly 126 (and thereafter the workpiece processing system 104). If the workpiece assessment generation engine 330 determines that the workpiece is unsuitable for the workpiece processing system 104, it can be diverted from the workpiece flow conveyance assembly 214 with a diverting mechanism before reaching the secondary organization assembly 126 (such as with a drop conveyor, a vacuum pick-up device, etc.).

A similar process may also or instead be used to assess processing aspects of a workpiece after the workpiece passes through the secondary organization assembly 126. As noted above, the automated infeed system 106 may further include a second organization assessment assembly located downstream from the secondary organization assembly 126. The second organization assessment assembly may similarly include a sensor assembly for collecting workpiece sensor data, and a computing device configured to process that sensor data and cause adjustment of one or more components of the automated line loading management system 102 as needed. In that regard, the computing device of a second organization assessment assembly may similarly include a workpiece assessment generation engine or the like configured to assess one or more processing aspects of a workpiece (e.g., size, temperature, etc.) to determine whether the workpiece is suitable for the workpiece processing system 104, or if the workpiece should instead be removed from the workflow or otherwise diverted to another area. If the workpiece is suitable for the workpiece processing system 104, it can be left on the workpiece flow conveyance assembly 214 for movement to the workpiece processing system 104. If the workpiece is unsuitable for the workpiece processing system 104, it can be diverted from the workpiece flow conveyance assembly 214 before reaching the workpiece processing system 104 (such as with a drop conveyor, a vacuum pick-up device, etc.). It can be appreciated that removal of unsuitable workpieces by a diverting or removal device may be easier after the workpieces have been secondarily organized (e.g., spaced, oriented, arranged, etc.).

In some examples, a computing device of the automated line loading management system 102, such as the data processing computing device 108, may be used to determine a suitable processing method for the workpiece(s) based on the assessment of one or more processing aspects of a workpiece(s) (e.g., size, temperature, etc.) and optionally any other data of primary organization assembly 122 or 122′, the organization assessment assembly 124 (and/or any second organization assessment assembly), and/or the secondary organization assembly 126. For instance, the data processing computing device 108 may carry out one or more computer-implemented methods for determining a suitable processing time or other processing parameter for a thermal processing system, such as an oven. For instance, one or more of the methods described in U.S. Pat. Nos. 9,366,580B2, 10,602,759B2, 10,123,557B2, 9,366,579B2, and 7,156,730B1, hereby incorporated by reference herein in their entirety, may be used.

Referring back to the discussion of the model generation engine 324, the model generation engine 324 may output a 2D and/or 3D model(s) to at least one of the secondary organization engine 326 (and/or the at least one data store 320) and the data processing computing device 108. For instance, the secondary organization engine 326 may receive or request a 2D and/or 3D model(s) from the model generation engine 324 (and/or the at least one data store 320) for executing a secondary organization algorithm. The secondary organization engine 326 may run a secondary organization algorithm to generate movement instructions for at least one secondary organization component of the secondary organization assembly 126 to move a secondary organization component into a position for correcting a position of a workpiece(s).

The primary organization engine 325 may similarly receive or request a 2D and/or 3D model(s) from the model generation engine 324 (and/or the at least one data store 320) for executing a primary organization algorithm. The primary organization engine 325 may run a primary organization algorithm to generate modulating instructions for the primary organization assembly 122′, such as movement instructions for the tote tipper 213′, loading instructions for a bulk storage transfer assembly, etc., to modulate the flow of workpieces downstream.

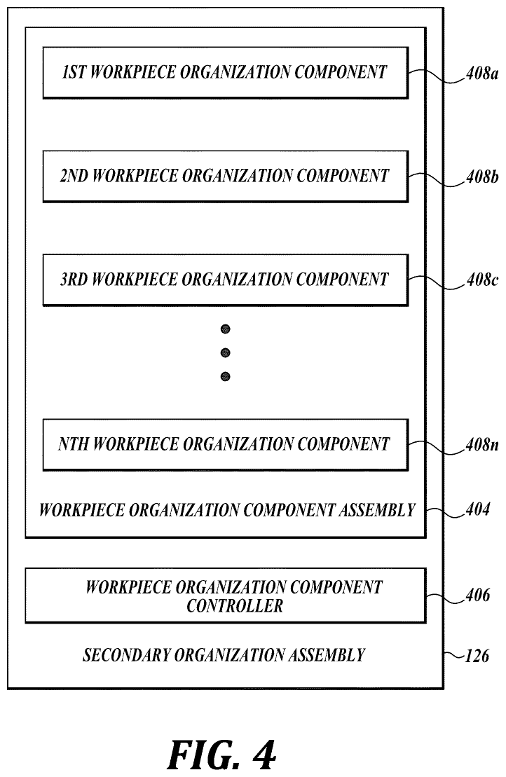

In some examples, the data processing computing device 108 may receive or request a 2D and/or 3D model(s) from the model generation engine 324 for executing one or more machine learning models to generate one or more workpiece organization plans or the like. The workpiece organization plan(s) may then be sent to the primary organization engine 325 and/or the secondary organization engine 326 of the organization computing device 312 and/or a controller of the primary organization assembly 122′ and/or secondary organization assembly 126 (such as the primary organization controller 216 or a secondary organization component controller 406, shown in FIG. 4). For instance, a workpiece organization plan may be sent to the primary organization engine 325 to adjust movement of the tote tipper 213′, the bulk storage transfer assembly, etc., to modulate the flow of workpieces downstream. A workpiece organization plan may also or instead be sent to the secondary organization engine 326 to cause movement of a secondary organization component into a position for correcting a position of a workpiece(s). In some examples, the one or more machine learning models are executed by the primary organization engine 325 and/or the secondary organization engine 326 of the organization computing device 312.

The model management computing device 107 or another suitable computing device (e.g., a cloud-based computing device in communication with the model management computing device 107) may be used to train the one or more machine learning models for use in the automated line loading management system 102. In that regard, the model management computing device 107 may receive or request workpiece sensor data generated by the organization computing device 312 or any other data for use in training machine learning models. For instance, the model management computing device 107 may receive or request sensor data for a workpiece from the sensor data processing engine 322 (e.g., after any pre-processing). The model management computing device 107 may also or instead receive or request a 2D and/or 3D model(s) from the model generation engine 324. tag

The model management computing device 107 may also receive or request data regarding primary organization assembly component settings or control profiles (e.g., from the primary organization controller 216), secondary organization assembly component settings or control profiles (e.g., from the secondary organization component controller 406), and workpiece processor machine settings or control profiles (e.g., retrieved from the processor computing device 120). The component and machine settings, including an initial setting and any adjusted or corrected settings corresponding to information in workpiece sensor data, may be used to train one or more machine learning models to generate a workpiece organization plan or the like.

Of note, the same or substantially similar pre-processing may be done for any data used for both training and using the machine learning models for optimal consistency, reliability, and speed. A further discussion of the training and use of one or more machine learning models for controlling aspects of workpiece organization will be described further below.

As can be appreciated from the foregoing, the primary organization assembly 122 performs a primary organization of the workpieces, such as by spreading the workpieces, eliminating stacked workpieces, and/or transitioning an aggregated supply of workpieces into a continuous flow. The primarily organized workpieces are conveyed to the organization assessment assembly 124, such as via the workpiece flow conveyance assembly 214, and the primary organization of the workpieces is assessed by the organization assessment assembly 124. For instance, the organization assessment assembly 124 captures sensor data of the workpieces (e.g., vision data), and based on that sensor data, one or more computing devices (e.g., the organization computing device 312 and/or the data processing computing device 108) determines whether further organization of some or all of the workpieces is required. If further organization is required, the organization computing device 312 and/or the data processing computing device 108 outputs corresponding data or instructions to the secondary organization assembly 126. The secondary organization assembly 126 receives or retrieves those data or instructions for carrying out a second, more precise organization of the workpieces as needed.

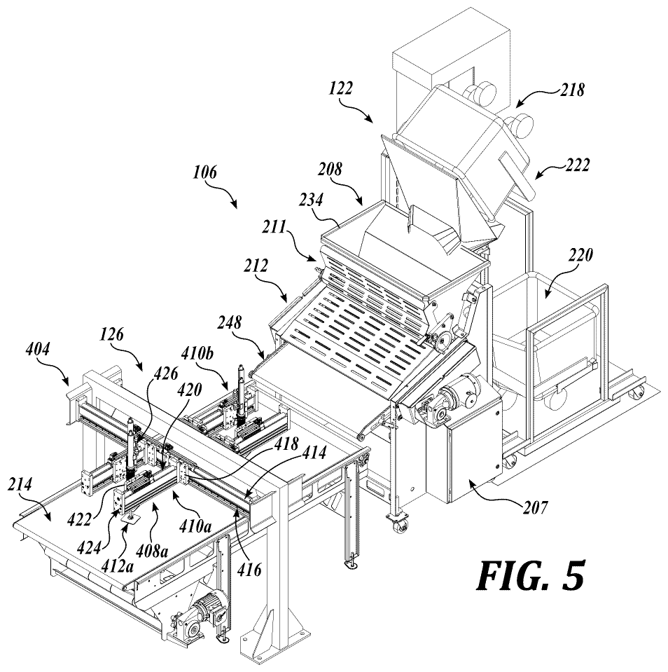

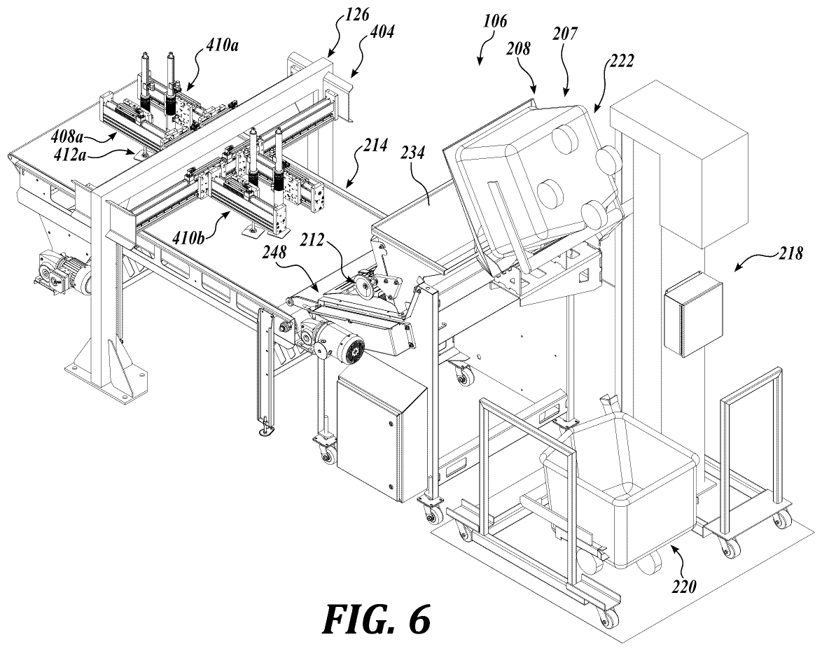

Exemplary aspects of the secondary organization assembly 126 will now be described with reference to the exemplary block diagram shown in FIG. 4 and the exemplary systems shown in FIGS. 5 and 6 (and also shown in FIGS. 7-8), wherein like components include the same reference number. Generally, the secondary organization assembly 126 includes a secondary organization component assembly 404 having organization components for carrying out a second, more precise organization of workpieces and a secondary organization component controller 406 configured for controlling aspects of the secondary organization component assembly 404.

The secondary organization component assembly 404 includes one or more organizing components for adjusting a position of a workpiece(s) on the workpiece flow conveyance assembly 214, such as by moving a workpiece to a different location on the conveyor, flipping a workpiece, changing an orientation of a workpiece, rearranging a workpiece, etc. The one or more organizing components can adjust a position of a workpiece(s) in a high-quality manner as is typically done with manual labor, yet without increasing the overall footprint of an infeed system.

The secondary organization component assembly 404 may include any type and number of organization components suitable for the intended application. For instance, the secondary organization component assembly 404 may include first, second, third, and n^{th} workpiece organizing components 408a, 408b, 408c, and 408d, respectively (hereinafter sometimes simply referred to as a “workpiece organizing component 408” or “workpiece organizing components 408”). The type and number of secondary organization components used may depend, for instance, on the type of workpieces being organized, the organization specifications of a corresponding workpiece processing machine, a size of the workpiece flow conveyance assembly 214, a quantity of workpieces being moved by the workpiece flow conveyance assembly 214, etc.

In the exemplary secondary organization assembly 126 shown in the exemplary automated infeed system 106 of FIGS. 5 and 6 (wherein the organization assessment assembly 124 is not shown), the secondary organization component assembly 404 is configured as at least one ultra-compact (densely arranged), purpose built, prime mover array having end effectors. For instance, each of the workpiece organizing components 408 may be configured as prime movers (hereinafter “prime mover 408”) each with an end effector 412 in an array(s), wherein the prime movers 408 work in coordination to further organize the workpieces. Each prime mover 408 with end effector 412 may be substantially identical; and therefore, only a first prime mover 408a having a first end effector 412a will be described in detail.

A first array 410a may include the first prime mover 408a configured to move in multiple directions to position the first end effector 412a for engagement with a workpiece(s) (e.g., picking up, capturing, sliding beneath, etc.). In some examples, the first prime mover 408a is a linear actuator system having linear actuator assemblies configured to move the first end effector 412a in at least x- y-, z-, and theta axis directions. For instance, the first prime mover 408a may include a first linear actuator assembly 414 having a first linear movement axis extending along a support beam 416 positioned above and extending substantially transversely across a width of the workpiece flow conveyance assembly 214. For instance, first and second ends of the support beam 416 may be secured to brackets (not labeled) extending upwardly from a frame of the workpiece flow conveyance assembly 214 to suitably position the support beam above the conveyor.

The first linear actuator assembly 414 has a first linear motor configured to move a first load plate 418 a length of the support beam 416 along the first linear movement axis, such as along a linear guide defined on or otherwise secured to the support beam. The first load plate 418 carries a second linear actuator assembly 420 having a second linear movement axis transversely oriented relative to the first linear movement axis of the first linear actuator assembly 414. The second linear actuator assembly 420 has a second linear motor configured to move a second load plate 422 a length of a cross beam 424 (such as on a linear guide) extending substantially transversely from the first load plate 418 (and substantially transversely from the first linear movement axis).

The second load plate 422 carries a third linear actuator assembly 426 having a third linear movement axis transversely oriented relative to the first and second linear movement axes of the first and second linear actuator assemblies 414 and 420. The third linear actuator assembly 426 has a third linear motor configured to move the first end effector 412 linearly along the third linear movement axis. The third linear actuator assembly 426 may also include a rotary motor for rotating the first end effector 412 about the third linear movement axis. In that regard, the third linear actuator assembly 426 may be considered a linear rotary actuator assembly.

As can be appreciated, the first, second, and third linear actuator assemblies 414, 420, and 426 of the first prime mover 408a enable movement of the first end effector 412 about an x-, y-, and z-axis, as well as a theta axis (with the x-, y-, and z-axis corresponding to the first, second, third linear movement axes, respectively). In that regard, the first end effector 412a may be moved into a position for engaging any workpiece that is within the range of the first prime mover 408a. More specifically, the first end effector 412a may be moved along an x-, y-, and z-axis relative to a conveyor belt of the workpiece flow conveyance assembly 214 along a distance at least as long as a stroke length of the corresponding linear motor. In that regard, in some examples, it may be beneficial to use two or more prime movers in an array to ensure all the workpieces can be reached for a certain belt width within a certain amount of time.

For instance, the first array 410a of the secondary organization component assembly 404 may also include second, third, and fourth prime movers 408b, 408c, and 408d, as shown in FIG. 5. In the depicted example, each of the second, third, and fourth prime movers 408b, 408c, and 408d, which are substantially identical to the first prime mover 408a as noted above, may have a first linear actuator assembly 414 mounted to the support beam 416. In that manner, each of the second, third, and fourth prime movers 408b, 408c, and 408d may be moveable along the same, first linear movement axis. However, the first, second, third, and fourth prime movers 408b, 408c, and 408d are spaced along the length of the support beam 416 so that each prime mover can reach a different section of the workpiece flow conveyance assembly 214 conveyor belt across its width.

In some examples, the secondary organization component assembly 404 may further include a second array 410b that may be substantially identical to the first array 410a. The second array 410b may be spaced from the first array 410a along a length of the conveyor belt of the workpiece flow conveyance assembly 214 to increase an organization capacity of the secondary organization assembly 126. In other words, the second array 410b, positioned from the first array 410a along a length of the conveyor belt, can reach workpieces further along the second linear movement axes.

In the depicted example, the second linear movement axis of each prime mover is substantially parallel to a longitudinal axis of the conveyor belt. In that regard, using multiple arrays along a length of the conveyor belt allows for increased organization capacity of the secondary organization assembly 126. It should be appreciated that any suitable combination of prime mover arrays may be used for the intended application. Moreover, any suitable linear and rotary actuators may be used to accommodate the intended application. For instance, the linear and rotary actuators may use linear and rotary motors available from LinMot® or another suitable source. A linear motor can achieve high precision, fast movement with an extremely small footprint.

In some examples, the workpiece organizing components 408 may include one or more orientation tables configured to adjust an orientation of a workpiece as it is moved through the secondary organization assembly 126. For instance, an orientation table may be positioned upstream or downstream from a prime mover array. If, based on scan data of the sensor assembly 304, workpieces are incorrectly oriented, those incorrectly oriented workpieces may be picked or moved from the workpiece flow conveyance assembly 214 by the prime mover array and placed on an orientation table or a conveyer leading to such a table.

In some examples, the workpiece organizing components may be configured as industrial robots, as shown in the exemplary automated infeed system 106′ of FIG. 11. For instance, a secondary organization assembly 126′ may include a secondary organization component assembly 404′ having a plurality of industrial robots 408′, such as first, second, and third industrial robots 408a′, 408b′, and 408c′. Such a configuration may be suitable for a workpiece processing line that has a lower density of workpieces to be organized, such as for a high-speed portioner or for more durable workpieces that would not be damaged by robots. In any event, a single industrial robot may consume the same space (belt length) as one of the prime mover arrays that can support multiple prime movers. Accordingly, industrial robots may be more suitable for applications that are not restricted by floor space or belt length.

In the example shown in FIG. 11, the secondary organization component assembly 404′ is a standalone, readily deployable unit that can be positioned where needed relative to the workpiece flow conveyance assembly 214, replaced when needed, etc. For instance, if an operational issue occurs (e.g., a workpiece organizing components 408′ malfunctions), the standalone secondary organization component assembly 404′ may be moved aside and replaced with manual labor. Such flexibility increases the reliability of the automated line loading management system 102 because the line can be kept up and running in the event of a secondary organization component or assembly failure. The standalone secondary organization component assembly 404′ may be used with a standalone vision system 308′ for enhanced automated line loading management system flexibility and reliability. Like the standalone vision system 308′, the standalone secondary organization component assembly 404′ may include an on-board data processor and/or be in communication with a separate computing device.

As noted above, an end effector 412 is configured for engagement with a workpiece(s) when moved into a suitable position by the corresponding prime mover 408. In that regard, and with reference to the first prime mover 408a, the first end effector 412a may be on a distal end of the third linear (rotary) actuator assembly 426 for engaging a workpiece when moved into an appropriate position. Any suitable first end effector 412a may be used for the intended application. For instance, grippers may be used for grasping a workpiece to move the workpiece. Any suitable grippers may be used, such as impactive grippers, ingressive grippers, astrictive grippers, and/or contigutive grippers.

For instance, the grippers may be configured for picking up workpieces and moving the workpieces to another belt location (or placing the workpieces). The grippers may instead or additionally be configured for capturing or grasping workpieces and sliding the workpieces to another belt location. The grippers may instead or additionally be configured for flipping workpieces. The grippers may instead or additionally be configured for rearranging or adjusting an orientation of the workpieces.

The end effectors 412 may also be configured to handle a workpiece without damaging a workpiece. Thus, a first type of gripper may be used to handle a delicate workpiece like raw chicken, whereas a second type of gripper may be used to handle a more durable workpiece like whole vegetables. Each prime mover may have the same end effector, or a mix of different end effectors may be used in each array or within the arrays. In some examples, one or more of the end effectors 412 may be configured like one of the exemplary end effectors shown and described in U.S. Provisional Patent Application No. 63/744,072, entitled “Non-Lifting End Effector”, the entire disclosure of which is hereby incorporated by reference herein.

The components of the secondary organization component assembly 404/404′, such as the workpiece organizing components 408/408′ or prime movers, may be controlled by the secondary organization component controller 406. The secondary organization component controller 406 may be any suitable controller configured to instruct the workpiece organizing components 408/408′ to move into an appropriate position relative to a workpiece(s) and activate the corresponding end effector.

In some examples, the secondary organization component controller 406 may receive secondary organization instructions from one or more of the organization computing device 312 (e.g., from the secondary organization engine 326) and the data processing computing device 108. For instance, as noted above, the secondary organization engine 326 of the organization computing device 312 may run a secondary organization algorithm (e.g., based on sensor data) to generate movement instructions for at least one secondary organization component of the secondary organization assembly 126/126′. The movement instructions may be sent to the secondary organization component controller 406. In response to those instructions, the secondary organization component controller 406 may activate one or more components of the secondary organization component assembly 404/404′ to move the workpiece organizing components 408/408′ into an appropriate position relative to a workpiece(s).

In some examples, the organization computing device 312 (e.g., the secondary organization engine 326) and/or the data processing computing device 108 may execute one or more machine learning models (e.g., based on sensor data as input) to generate a workpiece organization plan as output. The workpiece organization plan may be sent to the secondary organization engine 326 of the organization computing device 312 and/or the secondary organization component controller 406 to cause movement of workpiece organizing components 408/408′ into an appropriate position relative to a workpiece(s).

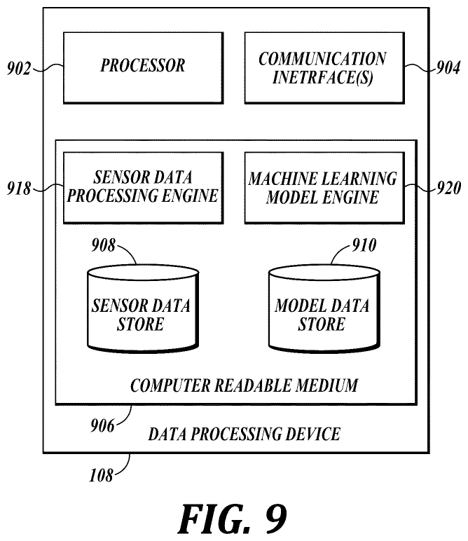

Referring to FIG. 9, exemplary aspects of the data processing computing device 108 will now be described in further detail. In the exemplary block diagram of FIG. 9, the data processing computing device 108 includes a processor(s) 902, a communication interface(s) 904, computer readable medium 906, and at least one data store, such as a sensor data store 908 and a model data store 910. As shown, the computer readable medium 906 has stored thereon logic that, in response to execution by the one or more processor(s) 902, may cause the data processing computing device 108 to provide a sensor data processing engine 918 and a machine learning model engine 920.

The data processing computing device 108 may be a local, high bandwidth computer such as an edge computing device, similar to that described in U.S. Provisional Patent Application No. 63/588,917, entitled “Edge Computing Device System And Method” hereby incorporated by reference in its entirety. The data processing computing device 108 may be implemented by a single computing device or collection of computing devices (e.g., a laptop computing device, a desktop computing device, a tablet computing device, a smartphone computing device, etc.) and may use any suitable processor(s) and communication interface(s), such as discussed above with respect to the organization computing device 312.

In one example, the data processing computing device 108 may be configured as a NVIDIA Jetson Orin package, such as an Advantech MIC-711-OX. A TCP/IP connection may be used to transfer data between the data processing computing device 108, the organization computing device 312, the secondary organization component controller 406, and/or the processor computing device 120.

It should be appreciated that in some examples, the data processing computing device 108 and the organization computing device 312 (and any other computing device of the automated line loading management system 102) may be integrated into a single computing device. In other words, functional computing aspects of the organization computing device 312 and the data processing computing device 108 may instead be carried out by a single computing device. In that regard, in any of the examples described herein, functional aspects of computing devices may be carried out by any one of or any combination of the computing devices described herein or any other computing devices.

However, it should also be appreciated that certain aspects of the systems and methods disclosed herein include generating sensor data with an organization computing device and sending that sensor data to a local, high power or edge computing device. In this manner, a heavy load of processing the sensor data and providing highly accurate and relevant output information for use in managing the workpiece organization can be easily achieved and managed by a separate computing device.

The data processing computing device 108 may be generally configured to receive sensor data for a workpiece(s) from the organization computing device 312 and/or any components of the primary organization assembly 122 and process that sensor data in the sensor data processing engine 918 (and optionally store that data in the sensor data store 908). Processing the sensor data may include performing any post-processing or formatting of the sensor data for use by the machine learning model engine 920.

The machine learning model engine 920 receives or retrieves the sensor data and executes one or more machine learning models (e.g., stored in the model data store 910) trained to generate an output based on information provided in the sensor data. For instance, the machine learning model engine 920 may send a machine learning model output back to the organization computing device 312. The organization computing device 312 can use that output to generate secondary organization instructions for the secondary organization component controller 406 of the secondary organization assembly 126/126′. The organization computing device 312 can also or instead use that output to generate primary organization instructions for the primary organization controller 216/216′ of the primary organization assembly 122/122′.

Exemplary machine learning models or other aspects of artificial intelligence configured to be carried out by the machine learning model engine 920 for managing aspects of the automated line loading management system 102 will now be described. It should be appreciated that the machine learning models are exemplary only, and other variations of the models described and/or additional models or other artificial intelligence techniques may also be used to achieve a similar or same result.

In one example, a secondary organization assembly optimization machine learning model may be configured to optimize organization of workpieces carried out by the secondary organization assembly 126/126′ using relevant workpiece data and other process data (e.g., workpiece processing infeed specifications) as input. For instance, the secondary organization assembly optimization machine learning model may output an optimal secondary organization configuration of workpieces for a certain area of the conveyor belt, such as the coverage area for one or more workpiece organizing components 408/408′, as defined by their reach capacity and any overlap therebetween.

The input may include processed organization assessment assembly sensor data regarding at least one of spacing between workpieces, workpiece position, workpiece orientation, workpiece spacing, workpiece arrangement, and workpiece type. For instance, the input may be at least one of a belt loading density on the belt and/or spacing between workpieces after passing the primary organization assembly 122/122′ (e.g., using image sensor data of the organization assessment assembly 124/124′), a percentage or number of overlapping or stacked workpieces on the belt (e.g., using image sensor data of the organization assessment assembly 124/124′), a size of the workpieces (e.g., determined from known workpiece specification data, the image sensor data of the organization assessment assembly 124/124′, etc.), a type of workpieces (e.g., chicken breast fillets v. nuggets), percentage of workpieces within an orientation specification, percentage of workpieces within an arrangement specification, etc.

The input may also include workpiece processing specifications, such as workpiece processing system infeed requirements (e.g., infeed belt speed, required workpiece spacing and/or arrangement, orientation, max infeed throughput level, etc.), workpiece processing system process specifications (e.g., oven temperature/humidity, dwell time, etc.), etc. The input may also include component specifications of the automated infeed system 106/106′, such as conveyor belt speed of the workpiece flow conveyance assembly 214, secondary organization component assembly capacity (e.g., movement/gripping capacity of prime movers), etc. The input may be represented as a string of numerical (optionally time-series) data, as image data, or any other suitable format.

As a specific example, if the belt loading density (or piece count per unit area of the belt) on the belt at the organization assessment assembly 124/124′ is 95%, and the workpiece processing system process specifications define a maximum belt coverage of 85% to achieve processing results, the secondary organization assembly optimization machine learning model may output an optimal organization configuration of workpieces for the conveyor belt to achieve 85% belt loading density. For instance, prime movers may move workpieces from areas of the belt having a high density (e.g., higher than 90 or 95%) to areas of a belt have a low density (e.g., less than 80%). In such an example, the automated infeed system 106/106′ may also incorporate a separate take away conveyor (which may define an infeed conveyor for the workpiece processing system) that is running at a different speed than the workpiece flow conveyance assembly 214 to allow the workpiece organizing components 408/408′ to effectively spread the workpieces on the takeaway conveyor. In some examples, the secondary organization assembly optimization machine learning model may operate independent of any primary organization assembly optimization machine learning model used.

The secondary organization assembly optimization machine learning model may send model output data to one or more of the organization computing device 312 (e.g., the secondary organization engine 326), the secondary organization assembly 126/126′ (e.g., the secondary organization component controller 406), or another computing device or controller in communication with the automated line loading management system 102, which may use the model output data to generate and/or send organization instructions to the workpiece organizing components 408/408′. The instructions may include necessary steps for each of the workpiece organizing components 408/408′ to achieve the optimal organization configuration of workpieces defined by the model.

For instance, the instructions may include designating one of the prime movers to move or rearrange a workpiece in a specific section of the conveyor belt of the workpiece flow conveyance assembly 214 at a designated time (e.g., at an optimal time when passing by the prime mover). As noted above, in the example of the first array 410a, the first, second, third, and fourth prime movers 408b, 408, and 408 are spaced along the length of the support beam 416 so that each prime mover can reach a different section of the conveyor belt across its width. The prime mover designated in the instructions may depend on the assigned conveyor belt section of each prime mover and the workpiece organization needed (e.g., moving, sliding, flipping, rearranging, etc.).

In some examples, a first designated prime mover section of the conveyor belt across its width may overlap with a second designated prime mover section of the conveyor belt. In such examples, the most optimal prime mover may be selected for carrying out organization of a workpiece in the first and/or second prime mover sections. In some examples, the prime mover sections may have distinct boundaries such that only the prime mover for that section may be selected. As noted above, the workpiece flow conveyance assembly 214 (and/or a vibration shaker table) may include lane dividers extending along a length of the conveyor belt or workpiece flow path. The lane dividers may correspond to a designated section of each of the second, third, and fourth prime movers 408b, 408c, and 408d. In that regard, the lane dividers may serve as a visual or physical reference for the prime movers and can simplify generation of the workpiece organization instructions.

The lane dividers can also create a minimum spacing between workpieces across portions of the belt, which can minimize the need for a prime mover to separate touching or overlapping pieces at or near the prime mover section boundary. As can be appreciated, a prime mover section boundary is far from a prime mover “home position”, which may be in substantially a center of a prime mover section. If the prime mover does not have to travel far from a prime mover “home position”, the speed of the prime mover and the overall speed of the secondary organization assembly 126/126′ is optimized.

In some examples, the lane dividers may be adjustable in position to accommodate workpiece specifications (e.g., size, shape, etc.), workpiece infeed requirements, secondary organization assembly 126/126′ (e.g., prime mover) specifications, etc. For instance, the lane divider position can be manually or automatically defined at a beginning of a workpiece processing shift based on workpiece specifications and requirements for the workpiece processing system infeed.

The lane divider position can instead or additionally be defined by the organization assessment assembly 124/124′ or a computing device in communication with the automated line loading management system 102. For instance, one or more machine learning models may be used to recommend lane divider positions to help balance and optimize a primary organization of workpieces on the belt. In some examples, a lane divider optimization machine learning model may be configured to output recommended lane divider positions of the primary organization assembly 122/122′ using relevant workpiece data and other process data as input. For instance, the input data may include workpiece type, bulk storage supply size (e.g., tote and corresponding tote tipper size), workpiece specifications, workpiece processing system infeed requirements, secondary organization assembly 126/126′ (e.g., prime mover) specifications, etc.

Any suitable type of artificial intelligence may be used, including machine learning models that incorporate computer vision and/or image segmentation, optionally incorporating deep learning techniques. In one example, the secondary organization assembly optimization machine learning model may be able to identify separate workpieces on the workpiece flow conveyance assembly 214 by segmenting or “cutting out” an object, feature, etc., in an image. The secondary organization assembly optimization machine learning model may incorporate the Segment Anything Model (SAM) available from Meta AI, FastSAM from Ultralytics, or another suitable image segmentation model using image segmentation techniques.

The above-described exemplary aspects of a machine learning model may be used to optimize organization of workpieces carried out by the secondary organization assembly 126/126′. In further aspects, one or more machine learning models or other artificial intelligence technologies may be used to optimize organization of workpieces carried out by the primary organization assembly 122/122′. For instance, the organization of workpieces leaving the primary organization assembly 122/122′ may be optimized to support capabilities and requirements of the workpiece supply assembly (e.g., workpiece supply assembly 218), and/or the downstream, secondary organization assembly 126/126′, and/or manual labor, and/or the workpiece processing system 104.

For instance, the organization of workpieces leaving the primary organization assembly 122/122′ may be optimized to enable the secondary organization assembly 126/126′ to meet downstream workpiece processing system requirements, preferences, throughput goals or optimization, efficiencies, etc. For instance, the primary organization assembly 122/122′ may be optimized to enable the secondary organization assembly 126/126′ to meet downstream workpiece processing system requirements, preferences, throughput goals or optimization, efficiencies, etc.

In other instances, the primary organization assembly 122/122′ may be optimized based on the specifications of the incoming bulk supply. For example, if the bulk storage is a 200 kg tote of chicken breast fillets, the primary organization assembly 122/122′ may be optimized to organize chicken breast fillets being supplied with a workpiece supply assembly configured to tip a 200 kg tote (such as a tote tipper sized for a 200 kg tote). If the bulk storage is a 1000 kg tote of chicken breast fillets, the primary organization assembly 122/122′ may be optimized to organize chicken breast fillets being supplied with a workpiece supply assembly configured to tip a 1000 kg tote (such as a tote tipper sized for a 1000 kg tote). If the bulk storage is a 1000 kg tote of chicken butterflies, the primary organization assembly 122/122′ may be optimized to organize chicken butterflies being supplied with a workpiece supply assembly configured to tip a 1000 kg tote (such as a tote tipper sized for a 1000 kg tote). If the incoming bulk supply is sone by other methods, such as by pump, the organization assembly 122/122′ may be optimized accordingly.

In that regard, in one example, a primary organization assembly optimization machine learning model may be configured to optimize organization of workpieces carried out by the primary organization assembly 122/122′. Organization optimization of workpieces carried out by the primary organization assembly 122/122′ may include controlling one or more components of the primary organization assembly 122/122′ to target or achieve a workpiece density, an average spacing between workpieces, a maximum number of overlapping workpieces, a maximum number of stacked workpieces, a preferred workpiece orientation, a preferred workpiece arrangement, a workpiece throughput minimum, a workpiece throughput maximum, and workpiece continuous flow, etc.

In some examples, a primary organization assembly optimization machine learning model may be configured to output a primary organization assembly score regarding the efficacy of workpiece organization when it reaches the organization assessment assembly 124, using sensor data of the organization assessment assembly 124 as input, including any 2D and 3D models of workpieces generated from image sensor data. The primary organization assembly score may be indicative of primary organization assembly efficacy based on at least one of several categories. The categories may include belt loading density, percentage of overlaps and/or stacked workpieces, average spacing between workpieces, orientation of workpieces, arrangement of workpieces, gaps in continuous flow, etc.

The categories and/or the score may be particular to the type of workpiece, the specifications of the incoming bulk supply (e.g., size of tote and tote tipper), the workpiece processor machine requirements, the capabilities of the secondary organization component assembly 404/404′, etc. For instance, a score based on spacing between products may differ for portioner workpiece organization versus oven workpiece organization. A score based on workpiece organization for an incoming bulk supply of 1000 kg of chicken butterflies may differ from a score based on workpiece organization for an incoming bulk supply of 200 kg of chicken butterflies. A score based on workpiece organization for an incoming bulk supply of 1000 kg of chicken breast fillets may differ from a score based on workpiece organization for an incoming bulk supply of 1000 kg of chicken butterflies. The score may also depend on the type of supply assembly (e.g. tote tipper v. pump).

The categories and/or the score may be particular to a batch of workpieces or a length of conveyor belt of the workpiece flow conveyance assembly 214. For instance, if each batch introduced into the workpiece receiving assembly 208/208′ is separated slightly or otherwise able to be identified or tracked, a score based on workpiece organization (e.g., spacing between products) may be tracked for a particular batch. Such a score may then also be correlated to workpiece supply data for that batch, such as bin or tote size, supply type (e.g. tote tipper v. pump), tote tipper size, bin or tote tipping rates/frequency, tote loading speed/frequency, pump supply rates/frequency, elevated conveyor speed, etc.

In some examples, a batch of workpieces may be approximated to determine a corresponding score. For instance, a batch of workpieces may be approximated based on belt speed in relation to workpiece supply timing. In some examples, the score may account for all workpieces in a batch including an approximation of any overlap with an upstream or downstream batch. In some examples, a score may account for only a certain percentage of workpieces in a batch to exclude an approximation of any overlap with an upstream or downstream batch. For instance, a boundary (e.g., 10% of workpieces) between upstream and downstream batches may be excluded from the score calculation.

An individual primary organization assembly score may be provided as output for each category, and/or a cumulative primary organization assembly score may be provided based on some or all of the categories. In any event, a primary organization assembly score may be weighted depending on the importance of that category for controlling workpiece organization. For instance, in some examples, product spacing may be more important than belt loading density. In such an example, the score for product spacing may have greater influence on the final or cumulative primary organization assembly score and/or the control instructions for primary organization components.

A primary organization assembly score may be based at least in part on numerical data, such as from a comparison of workpiece sensor data gathered by the organization assessment assembly 124/124′ to reference target values. For instance, a numerical value may be assigned as a score and/or may be used to generate a score for a category based on a calculated difference between a measured value (e.g., workpiece spacing) and a target value.

A primary organization assembly score may be based at least in part on time series data, such as primary organization component data, organization assessment assembly data, secondary organization component data, and workpiece processing system data recorded over consistent intervals of time. Regarding primary organization component data, time series data may include tote loading speed, tote loading frequency, tote dumping rotational direction, frequency, and speed, bin tipper speeds and/or tipping intervals, vacuum pump speed and/or pumping intervals, elevated conveyor speeds, hopper gate speed and/or intervals, workpiece flow distribution assembly roller speeds and/or conveyor take away speeds, workpiece flow conveyance assembly 214 speeds, etc.

Regarding organization assessment assembly data, time series data may include workpiece spacing, workpiece size or shape, workpiece belt density, workpiece arrangement or orientation, etc.

Regarding secondary organization component data, time series data may include speeds and/or organization intervals of the workpiece organizing components 408/408′, percentage of workpieces missed by a prime mover(s), workpiece flow conveyance assembly 214 speeds, etc.

Regarding workpiece processing system data, time series data may include workpiece processing system infeed conveyor speed, workpiece processing system process parameters (e.g., oven temperature/humidity, throughput, yield, etc.), workpiece processing system anomalies (e.g., portioner “no cuts”), etc.

In some examples, the primary organization assembly optimization machine learning model may output a primary organization assembly score(s) to the primary organization controller 216 of the primary organization assembly 122/122′. The primary organization controller 216 may adjust one or more settings of the primary organization component assembly 207/207′ based on the score(s). For instance, the primary organization controller 216 may adjust one of a workpiece bulk supply transfer rate of the workpiece supply assembly 218 (e.g., bin or tote tipping speed and/or frequency, tote delivery speed/frequency, vacuum pump speed and/or frequency, conveyor elevator speed and/or frequency, etc.), a weight, volume, or quantity of workpieces supplied from the workpiece flow modulating assembly 211/211′ (e.g., with hopper gate timing, tote tipping speed and/or frequency, etc.), a roller speed(s) and/or a take-away conveyor speed of the workpiece flow distribution assembly 212/212′ (e.g., to help spread out or otherwise adjust the flow speed of workpieces), a conveyor belt speed of the workpiece flow conveyance assembly 214, etc.

As a non-limiting example, if a score representing at least one of workpiece spacing, density, thickness, stacking, orientation, arrangement, throughput, and continuity of flow indicates a less-than-optimal primary workpiece organization, the primary organization assembly optimization machine learning model may output a modified tote tipping profile to adjust the incoming supply of workpieces accordingly. More specifically, if a score representing a lower-than-optimal workpiece density on the primary organization assembly conveyor 223 (e.g., before the fixed weir 240′ and/or between the fixed and adjustable weirs 240′ and 242′), the tote tipper 213′ may be instructed to follow a more aggressive tote tipping profile (e.g., reaching a higher degree rotational dumping position at a faster rate). Conversely, if a score representing a higher-than-optimal workpiece density on the primary organization assembly conveyor 223 (e.g., before the fixed weir 240′ and/or between the fixed and adjustable weirs 240′ and 242′), the tote tipper 213′ may be instructed to follow a less aggressive tote tipping profile (e.g., reaching a lower degree rotational dumping position at a slower rate (e.g., radians/sec), periodically reversing rotational direction of the tote, etc.).

In some examples, data pertaining to a tote tipping profile, such as the type of workpiece, the size of incoming bulk supply (e.g., tote size and/or tote tipper size), the primary organization assembly score(s), the secondary organization assembly 126/126′ and/or workpiece processing system 104 requirements, processing system workpiece throughput requirements, etc., may be used to train the primary organization assembly optimization machine learning model. In that regard, upon recognition of a certain type of workpiece (e.g., using computer vision and/or image segmentation techniques of the machine learning model engine 920 to process image sensor data from the sensor(s) 210a′ and/or second image sensor 210b′ or other input identifying a type of workpiece) with a known size of incoming bulk supply, secondary organization assembly 126/126′ and/or workpiece processing system 104 requirements, processing system workpiece throughput requirements, etc., the primary organization assembly optimization machine learning model may output a recommended tote tipping profile(s). For instance, a specific tote tipping profile may be preferred for processing chicken tenders to be cooked in an oven, a specific tote tipping profile may be preferred for processing chicken breast fillets supplied with a 1000 kg tote tipper, a specific tote tipping profile may be preferred for processing chicken breast fillets supplied with a 200 kg tote tipper, etc.

As another non-limiting example, if a score representing workpiece spacing indicates that workpieces are closer to each other than is optimal for the secondary organization assembly 126/126′ (and/or manual labor and/or the workpiece processing system 104), a roller speed(s) and/or a take-away conveyor speed of the workpiece flow distribution assembly 212/212′ may be adjusted by the primary organization controller 216 in a manner corresponding to the score. For instance, the speed of the rollers and/or a take-away conveyor may be decreased to correspondingly spread out or otherwise adjust the flow speed of workpieces to move toward the target workpiece spacing.

In some examples, the primary organization assembly optimization machine learning model may be trained using historical data generated with process workpiece sensor data for workpieces that have been organized by the primary organization assembly 122/122′ or processed workpiece organization data from various workpiece layouts, such as layouts created manually or layouts captured during a portion of a workpiece processing process. The data may be processed, for instance, by performing at least one of annotating images, generating numerical data based on measurements in images, correlating sensor data (or data derived therefrom) to other parameters or data of the automated line loading management system 102 (e.g., the type of workpiece, the size and/or type of incoming bulk supply, etc.), etc.

In some examples, one or more primary organization assembly optimization machine learning models may be trained using primary organization assembly score(s). For training, primary organization assembly score(s) may be correlated to workpiece specifications, primary organization assembly component initial and adjusted settings or control profiles (including incoming bulk supply type, size, and supply profile), conveyor belt initial and adjusted speeds, workpiece processing system initial and adjusted settings, etc. For instance, if, based on a first primary organization assembly score for workpieces having first specifications, the primary organization assembly components or control profiles are adjusted to supply workpieces at a different rate (e.g., adjustment of bulk supply methods, adjustment of bin tipping speed, rotational direction, and/or frequency, vacuum pump speed and/or frequency, conveyor elevator speed and/or frequency, etc.), those adjustments can be correlated to the primary organization assembly score(s) for a specific configuration.

The component/machine setting or control profile adjustment data may be derived from operator input in response to a primary organization assembly score output and/or a recommendation output from a machine learning model correlated to a score. For example, if an operator receives a recommendation for component or machine setting adjustments (optionally with a score), the operator may accept the recommendation, reject the recommendation, and/or make manual adjustments based on the recommendation. The operator's input can be part of the training data.

In some examples, the primary organization assembly optimization machine learning model may output a primary organization assembly score(s) to the machine learning model engine 920 of the data processing computing device 108, which may use the score as input when executing another machine learning model. For instance, the score(s) may be used as input for a primary organization assembly optimization machine learning model that is trained using primary organization assembly score(s), as described just above. Such a primary organization assembly optimization machine learning model may output a primary organization assembly plan based on the primary organization assembly score(s) and any other relevant data (e.g., workpiece type, incoming supply type/size, primary organization assembly components settings or control profiles, conveyor belt speeds, workpiece processing system requirements, etc.) as input.

A primary organization assembly plan may include a recommended setting or control profile for one or more components of the primary organization component assembly 207 to achieve a target primary workpiece organization (e.g., a target primary organization assembly score(s)). The primary organization assembly optimization machine learning model may be trained, for instance, using historical score data generated by analyzing workpiece sensor data for workpieces that have been organized by the primary organization assembly 122/122′ with various settings for intended organization and/or processing goals.

A non-limiting example of a workpiece processing environment that may benefit from a primary organization assembly optimization machine learning model will now be described. In the example, the workpiece processing system may be an oven that can manage a certain amount of pounds per hour (e.g., 13650 pounds per hour) with a known retention time (e.g., 55 minutes), belt loading (e.g., 0.9 pounds per square foot) and belt coverage (e.g., 87%) The oven, with the defined parameters, may support a minimum spacing between products (e.g., 1.2 inches) at an oven infeed (e.g., based on historic data and application calculations). The primary organization assembly optimization machine learning model may receive input data regarding the work piece spacing, belt loading density, etc., achieved by the primary organization assembly, such as a primary organization assembly score(s). Based on the primary organization assembly score(s), the requirements of the oven, and any data regarding workpiece supply, the machine learning model may output recommended settings or control profiles for one or more of the primary organization assembly components to achieve a target workpiece spacing, belt loading density, etc.

For instance, the primary organization assembly optimization machine learning model may recommend that if a tote contains a certain mass of workpieces (e.g., 1912 pounds), the tote should be dumped and consumed by the primary organization component assembly 207 within a certain amount of minutes (e.g., 48 minutes) at a certain rate, a tote transfer assembly should supply a tote to a receiving assembly of the primary organization assembly 122/122′ at a certain speed and/or frequency or a vacuum pump should pump a certain number of loads per minute into a receiving hopper (e.g., 78 small loads of product, one batch every 47 seconds), a take away conveyor should operate at a certain speed (e.g., 85 fpm), etc., to provide target spacing between the workpieces for any downstream processing (e.g., such that the secondary organization assembly 126/126′, if used, may sufficiently perform secondary workpiece organization for supporting oven requirements).

In some examples, the primary organization assembly optimization machine learning model may optimize a primary organization assembly plan based on designated workpiece infeed preferences or processing preferences, such as per an operator or customer. For instance, a customer may have preferred adherence to portioning cut accuracy over throughput. In such an instance, the primary organization assembly optimization machine learning model may adjust the primary organization assembly plan to more closely target a necessary spacing or orientation of workpieces that allow for accurate portioning (versus belt loading density). The manner in which such optimization may be done may include aspects of the systems and methods described in, for instance, U.S. Pat. Nos. 9,128,810, 8,688,259 and 9,008,824, incorporated by reference herein in their entirety.

In some examples, the primary organization assembly optimization machine learning model may optimize a primary organization assembly plan based on workpiece orientation loading preferences of a workpiece processing system. For instance, systems and methods can be used meet production goals for different portion or cut requirements of a workpiece based on its orientation or arrangement on the belt (e.g., on its side, at a 45 degree angle, etc.), such as those described in U.S. Pat. Nos. 9,128,810, 8,688,259 and 9,008,824, incorporated by reference herein in their entirety. The primary organization assembly optimization machine learning model may output one or more recommended component settings or control profiles based on a target workpiece orientation for the workpiece processing system.

In some examples, the primary organization assembly optimization machine learning model may optimize a primary organization assembly plan based on workpiece processing system throughput or order filling requirements. For instance, systems and methods can be used meet production goals for different piece portions of a workpiece (e.g., sandwich portions v. nuggets), such as those described in U.S. Pat. Nos. 7,672,752 and 8,688,267, incorporated by reference herein in their entirety). In such an instance, the primary organization assembly optimization machine learning model may adjust the primary organization assembly plan to organize the workpieces in a manner that supports workpiece throughput (versus, e.g., spacing) to meet such production goals.

As a specific example, if a workpiece processing system has an 8-hour shift production goal (e.g., 80,000 pounds of finished product), a primary organization assembly optimization machine learning model may output a primary organization assembly plan based on time-series data of throughput estimates during the shift, machine settings or control profiles, primary organization component data, and secondary organization component data as input. The primary organization assembly plan may include recommended settings or control profiles for one or more components of the primary organization assembly 122/122′ and the secondary organization assembly 126/126′ to support the required throughput (e.g., setting recommendations for the tote dumper to provide approximately 40-2,000 pound totes per shift, a control profile of a tote tipper to supply a certain mass of workpieces at a certain rate, etc.).

The primary organization assembly optimization machine learning model may be expanded for use in managing production goals of multiple workpiece processing lines in a facility. For instance, an additional input may include the market supply of incoming, bulk workpieces. The primary organization assembly optimization machine learning model can output recommended settings for an automated line loading management system of one or more workpiece processing systems in a facility to optimize the market supply of incoming, bulk workpieces across the facility.

In some examples, the primary organization assembly optimization machine learning model may tailor recommended settings of one of more components of the primary organization assembly 122/122′ and/or the secondary organization assembly 126/126′ to keep workpiece flow slightly above a maximum level supported by the secondary organization assembly 126/126′ and/or the workpiece processing system. In such examples, the secondary organization component assembly 404 of the secondary organization assembly 126/126′ and/or the workpiece processing assembly 118 of the workpiece processing system 104 may be configured to remove excess workpieces from the conveyance system. Such an overflow supply of workpieces helps ensure that the workpiece processing system 104 is fed to substantially 100% of its capacity.

At the same time, the primary organization assembly optimization machine learning model may tailor recommended settings of one of more components of the primary organization assembly 122/122′ and/or the secondary organization assembly 126/126′ to keep workpiece flow at or below a maximum level supported by the secondary organization assembly 126/126′ and/or to keep workpiece infeed within a maximum level supported by the workpiece processing system 104. In some examples, the primary organization assembly optimization machine learning model may recommend a setting or control profile for component(s) of the primary organization assembly 122/122′ (e.g., the tote tipper 213′ and/or the bulk storage (e.g., tote) transfer assembly) to limit the infeed rate of the entire automated line loading management system 102.

As an example, a portioner line may have a shift goal totaling 24,000 pounds of portioned workpieces. However, the portioner may be configured to cut workpieces that require relatively long times to cut (e.g., extensive cutter movement), and because of that configuration, the portioner is limited to portioning 2500 pounds per hour or 20,000 pounds in an 8-hour shift. In such an example, the primary organization assembly optimization machine learning model may output a recommended setting(s) (such as for review by an operator) for the workpiece supply assembly 218 or another supply assembly to manage the incoming supply. For instance, a tote dumper may be instructed to supply only 2500 pounds per hour to a hopper 234 of the primary organization assembly 122, a tote transfer assembly may supply only one 2500 pound tote per hour to the workpiece receiving subassembly 209a′ of the primary organization assembly 122′, etc.

Similarly for an oven line, if the cooked product goal was 40,000 pounds for the shift, but if that production rate could not be reached without a belt coverage amount that exceeded “safe” limits (since the likelihood of workpieces touching or being stacked on top of each other increases with increasing belt coverage), then the primary organization assembly optimization machine learning model may output a recommended setting(s) or control profiles for the workpiece supply assembly 218 or another supply assembly to decrease the incoming supply. However, if time-series data of the organization assessment assembly 124/124′, such as workpiece size and belt loading density, indicated that a belt coverage decreased (e.g., the thickness of the product increased and the footprint of the product decreased), the primary organization assembly optimization machine learning model may output a recommended setting(s) or control profiles for the workpiece supply assembly 218 to increase the incoming supply.

Any suitable type of machine learning model(s) may be used, including but not limited to convolutional neural networks. Any suitable technique may be used to train the machine learning models, including but not limited to one or more of gradient descent, data augmentation, hyperparameter tuning, and freezing/unfreezing of model architecture layers. In some examples, annotated, raw images are used as the training input. In some examples, one or more features derived from the images, including but not limited to versions of the images in a transformed color space, set of edges detected in the image, one or more statistical calculations regarding the overall content of the images, or other features derived from the images may be used instead of or in addition to the annotated raw images to train the machine learning models. The machine learning model(s) used by a computing device may depend on which software application(s) is active within the computing device. For instance, depending on the software applications running on the data processing computing device 108, the corresponding machine learning model(s) may be called and executed in the machine learning model engine 920 of the data processing computing device 108.

A separate machine learning model may be used for each workpiece type, each type of bulk supply (e.g., tote tipper v. vacuum), each size of bulk supply (e.g., 200 kg v. 1000 kg), each workpiece processing system type (e.g., ovens, portioners, freezers, etc.), each type of primary organization assembly (e.g., primary organization assembly 122 or primary organization assembly 122′) each type of secondary organization assembly 126 (e.g., prime moves v. robotic actuators), etc. In some examples, the machine learning model(s) used is unique to a type of workpiece organized and processed by a specific configuration of an automated infeed system 106 and workpiece processing system 104 (a “line”) of the automated line loading management system 102. For instance, a first machine learning model(s) may be used to organize and process chicken breast fillets, and a second machine learning model(s) may be used to organize and process chicken butterflies on the same line. In some examples, the same first machine learning model(s) may be used to organize and process chicken breast fillets on the same line for different throughput targets (e.g., 500 pounds per hour v. 2000 pounds per hour).

In some examples, the machine learning model(s) used are unique to a combined configuration of primary organization assembly 122/122′ and secondary organization assembly 126/126′. For instance, a first machine learning model(s) may be used to optimize primary and secondary organization of the primary organization assembly 122 and secondary organization assembly 126 shown in FIG. 5, and a second machine learning model(s) may be used to optimize primary and secondary organization of the primary organization assembly 122′ and secondary organization assembly 126′ shown in FIG. 11.

In other examples, the machine learning model(s) used for optimizing the primary organization assembly 122/122′ (or the primary organization assembly optimization machine learning model(s)) is independent of the machine learning model(s) used for optimizing the secondary organization assembly 126. In other words, a primary organization assembly optimization machine learning model(s) for a workpiece type and supply type/size may be used for optimizing primary organization regardless of the secondary organization assembly 126/126′ configuration or the machine learning model(s) used for optimizing the secondary organization assembly 126/126′. Referring back to FIG. 1, the automated line loading management system 102 further includes a monitoring system 110, which may be embodied in any computing device in networked communication with the workpiece processing system 104, the automated infeed system 106, and/or the data processing computing device 108. The monitoring system 110 includes a processor(s) (not shown) and computer readable medium having logic stored thereon that, in response to execution by the processor(s), causes the monitoring system 110 to provide a workpiece data processing engine 128 and an organization assessment reporting engine 130.

The workpiece data processing engine 128 is generally configured to receive and analyze workpiece organization data received from the organization computing device 312. Analysis of the workpiece organization data may include compiling information for a certain machine or production run (e.g., average workpiece belt loading density, average workpiece spacing, etc.), comparing workpiece organization data between production runs, etc. The organization assessment reporting engine 130 may be configured to report the workpiece organization data by arranging the data and displaying the data to a viewer. In that regard, the monitoring system 110 is generally configured to monitor the workpiece organization process and provide insight into the workpiece organization process, such as for optimizing the workpiece organization process, identifying any gaps in the workpiece organization process, troubleshooting machine equipment or settings/profiles based on workpiece organization process results, etc.

FIGS. 10A and 10B depict views of an exemplary automated line loading management system 102 having a primary organization assembly 122, an organization assessment assembly 124, a secondary organization assembly 126, and a workpiece processing system 104. In the depicted exemplary automated line loading management system 102, the primary organization assembly 122 includes a C.A.T. VacCAT Product Distribution System™, as referenced herein. A tote dumper, vacuum system, or other workpiece supply assembly is not shown. The organization assessment assembly 124 may include a vision system, which may be enclosed in a housing together with the secondary organization assembly 126. In the depicted example, the workpiece processing system 104 is a workpiece portioner, such as a DSI™ 800 Portioning System available from JBT Corporation of Chicago, IL.

As noted above, FIG. 11 shows an exemplary automated line loading management system 102′ having the primary organization assembly 122′ described above, as well as a standalone, readily deployable vision system sensor 308′ and a standalone, readily deployable secondary organization component assembly 404′.

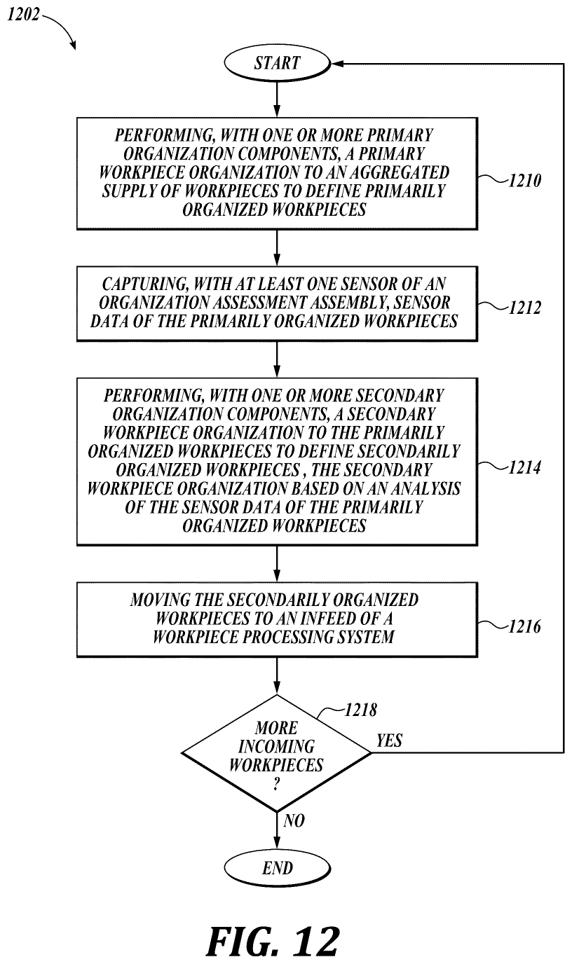

FIG. 12 is a flowchart of a non-limiting example of a method of organizing an infeed of workpieces for a workpiece processing system. The method 1202 may be carried out using any components described herein with reference to the automated line loading management system 102, or any other suitable components. For ease of description, aspects of the method may be described with reference to the primary organization assembly 122/122′, the organization assessment assembly 124/124′, the secondary organization assembly 126/126′, and the workpiece processing system 104, although aspects of the method should not be limited to such components. Moreover, aspects of the method may be carried out by the data processing computing device 108, the organization computing device 312, or any other suitable computing device, including one or more of the controllers described herein.

From a start block, the method 1202 may proceed to block 1210, which includes performing, with one or more primary organization components, a primary workpiece organization to an aggregated supply of workpieces to define primarily organized workpieces. The aggregated supply of workpieces may be supplied from the workpiece supply assembly 218 (or another supply assembly) to the primary organization assembly 122/122′ in any suitable manner, such as with a tote transfer assembly, a tote dumper/tipper, a vacuum system, etc.

The primary workpiece organization may be performed with the primary organization assembly 122/122′ having a primary organization component assembly 207/207′. The primary organization component assembly 207/207′, as described herein, may include a workpiece receiving assembly 208/208′, a workpiece flow metering assembly 210/210′, a workpiece flow modulating assembly 211/211′, a workpiece flow distribution assembly 212/212′, and a workpiece flow conveyance assembly 214. In some examples, a C.A.T. VacCAT Product Distribution System™ is used, such as in the examples shown in FIGS. 5-7, 10A, 10B, and 11. In some examples, a vibration assembly and/or lane dividers are used, such as in the examples shown in FIGS. 7 and 8. In some examples, a controlled tote tipper 213′ and horizontally oriented hopper 221′ is used, as shown in FIGS. 2E and 2F.

The method 1202 may proceed to block 1212, which includes capturing, with at least one sensor of an organization assessment assembly, sensor data of the primarily organized workpieces. For instance, sensor data may be captured by the sensor assembly 304 of the organization assessment assembly 124/124′, such as a vision system 308/308′ and an optional weight station 310. In that regard, in some examples, the method 1202 may include capturing image sensor data of the primarily organized workpieces with an image sensor assembly (e.g., image sensor(s) 210a′ and 210b′), generating, with a computing device (e.g., the organization computing device 312), at least one of a 2D model and a 3D model of the primarily organized workpieces using the image sensor data, and performing, with a computing device (e.g., the organization computing device 312 and/or the data processing computing device 108), an analysis of the image sensor data of the primarily organized workpieces.

In some examples, the method 1202 may include processing, with a computing device (e.g., by the organization computing device 312 and/or the data processing computing device 108), sensor data of the primarily organized workpieces to determine at a workpiece mass flow, average spacing between workpieces, workpiece position, a percentage of overlapping workpieces, a percentage of stacked workpieces, workpiece size, workpiece type, percentage of workpieces within an orientation specification, percentage of workpieces within an arrangement specification, etc.

In some examples, one or more machine learning models may be executed (e.g., by the data processing computing device 108) to output a primary organization assembly score using sensor data of the primarily organized workpieces as input. The primary organization assembly score may be indicative of primary organization assembly efficacy based on at least one of several categories, including workpiece belt loading density, percentage of workpiece overlaps, percentage of stacked workpieces, average spacing between workpieces, percentage of workpieces within an orientation specification, percentage of workpieces within an arrangement specification, and gaps in continuous flow of workpieces. The primary organization assembly score may be specific to at least one of a batch of workpieces organized by the primary organization assembly and a length of conveyor belt of a movement assembly containing workpieces organized by the primary organization assembly.

The primary organization assembly score may be based on at least one of primary organization component time series data, organization assessment assembly time series data, secondary organization component time series data, and workpiece processing system time series data.

The primary organization component time series data may include at least one of tote loading speed, tote loading frequency, tote dumping rotational direction, frequency, and speed, bin tipper speeds and/or tipping intervals of a workpiece supply assembly, vacuum pump speed of a vacuum pump system of a workpiece supply assembly, pumping intervals of a vacuum pump system of a workpiece supply assembly, elevated conveyor speeds of a workpiece supply assembly, hopper gate speeds of a workpiece supply assembly, hopper gate intervals of a workpiece supply assembly, roller speeds of a workpiece flow distribution assembly, and movement assembly speed. The organization assessment assembly time series data may include at least one of workpiece spacing, workpiece size, workpiece shape, workpiece density on a workpiece movement support surface, workpiece arrangement, and workpiece orientation. The secondary organization component time series data may include at least one of workpiece organizing component speed, workpiece organizing component intervals, percentage of workpieces missed by a workpiece organizing component, and movement assembly speed. The workpiece processing system time series data may include at least one of infeed conveyor speed, workpiece processing system process parameters, and workpiece processing system anomalies.

The primary organization assembly score may be used for controlling one or more components of the primary organization assembly to target a workpiece density, an average spacing between workpieces, a maximum number of overlapping workpieces, a maximum number of stacked workpieces, a preferred workpiece orientation, a preferred workpiece arrangement, a workpiece throughput minimum, a workpiece throughput maximum, and workpiece continuous flow.

Controlling one or more components of the primary organization assembly may include at least one of adjusting a workpiece bulk supply transfer rate of a workpiece supply assembly, modulating workpieces with a workpiece flow modulating assembly, adjusting a speed of a roller assembly of a workpiece flow distribution assembly, adjusting a take-away conveyor speed of a workpiece flow distribution assembly, and adjusting a movement speed of the movement assembly. Adjusting a workpiece bulk supply transfer rate of a workpiece supply assembly may include adjusting at least one of a tote loading speed, tote loading frequency, vacuum pump speed of a vacuum pump system, pumping intervals of a vacuum pump system, tote or bin tipper speeds, bin tipping intervals, elevated conveyor speeds, etc. For instance, after a tote T is emptied, the bulk supply receiving subassembly 209a′ may be instructed to return to a receiving position at a sufficiently fast speed to release the emptied tote and accept a new loaded tote T. Reloading the tote T faster can increase a supply rate of the workpieces to the workpiece receiving assembly 208/208′, and it can even support a substantially continuous flow of workpieces to the workpiece receiving assembly. In some examples, the tote T may be automatically reloaded, such as using the examples described herein, and/or an alarm or notification may be provided to alert an operator to change the tote.

Modulating workpieces with a workpiece flow modulating assembly may include adjusting at least one of a tote loading speed, tote loading frequency, tote dumping rotational direction, tote dumping frequency, tote dumping speed, bin pumping intervals of a vacuum pump system, hopper gate speeds, hopper gate intervals, etc. For instance, to increase a mass flow of workpieces through the primary organization assembly 122/122′, an emptied tote may be quickly and efficiently reloaded as discussed above. In addition or in the alternative, a tote dumping profile may be adjusted to increase a speed, rotational direction, rotational position, movement frequency, etc., of a tote dumper, such as tote tipper 213′.

In some examples, one or more machine learning models (e.g., a primary organization assembly optimization machine learning model(s)) may be executed (e.g., by the data processing computing device 108) to output a primary organization assembly plan using at least one of a primary organization assembly score (such as the primary organization assembly score described above), workpiece type, incoming bulk supply size/type, workpiece supply assembly size/type, and workpiece processing specifications as input. The workpiece processing specifications may include at least one of workpiece processing system infeed requirements, workpiece processing system process specifications, conveyor belt speed of a workpiece movement assembly, and secondary organization component assembly requirements.

The primary organization assembly plan may include a recommended setting and/or control profile for one or more components of the primary organization component assembly to achieve a target primary workpiece organization score. The primary organization assembly plan may include at least one of modulating a mass supply and/or flow of workpieces and/or distributing workpieces to, for instance, support a continuous distribution of workpieces across at least one of a length and width of the movement assembly and/or to support transitioning the aggregated supply of workpieces to a course evenflow of workpieces.

The method 1202 may proceed to block 1214, which includes performing, with one or more secondary organization components (e.g. workpiece organizing components 408/408′), a secondary workpiece organization to the primarily organized workpieces to define secondarily organized workpieces, the secondary workpiece organization based on an analysis of the sensor data of the primarily organized workpieces.

In some examples, a secondary organization algorithm may be executed (e.g., by the organization computing device 312 and/or the data processing computing device 108) based on the analysis and workpiece processing specifications to generate instructions for moving at least one secondary organization component (e.g., workpiece organizing components 408/408′) of the secondary organization assembly into a location for adjusting a position of at least one of the primarily organized workpieces.

In some examples, the method 1202 may include executing one or more machine learning models (e.g., a secondary organization assembly optimization machine learning model(s)) that output a workpiece organization plan including instructions for moving at least one secondary organization component of the secondary organization assembly into a location for correcting a position of a workpiece using sensor data of the primarily organized workpieces and workpiece processing specifications as input. The workpiece processing specifications may include workpiece processing system infeed requirements, workpiece processing system process specifications, conveyor belt speed of the movement assembly, secondary organization component assembly, etc.

The workpiece organization plan may include instructions for adjusting settings of one of more components of the primary organization assembly and the secondary organization assembly to substantially maintain workpiece flow above a maximum level supported by the secondary organization assembly and a workpiece processing system, respectively. The workpiece organization plan may include instructions for removing excess workpieces from a movement assembly by at least one of a secondary organization component assembly of the secondary organization assembly and a workpiece processing assembly of the workpiece processing system.

In some examples, the method 1202 may include performing the secondary workpiece organization with at least a first prime mover array (e.g., first array 410a) having first and second prime movers (e.g. prime movers 408) with corresponding first and second end effectors (e.g., end effector 412), the first and second prime movers locatable across a width of the movement support surface such that the first prime mover is configured to locate its end effector in a first prime mover section defined by a first width of a movement support surface and the second prime mover is configured to locate its end effector in a second prime mover section defined by a second width of the movement support surface, wherein the first and second prime mover sections extend along substantially a same length of the movement support surface (e.g., workpiece flow conveyance assembly 214).

The method 1202 may proceed to block 1216, which includes moving the secondarily organized workpieces to an infeed of a workpiece processing system, such as moving the secondarily organized workpieces via workpiece flow conveyance assembly 214 to workpiece processing system 104.

In some examples, such as described above with respect to FIG. 11, the secondary organization assembly 126/126′ may be excluded or removed for a certain workpiece organization application. In that regard, the method 1202 may exclude block 1214, and block 1216 may instead include moving the primarily organized workpieces to an infeed of a workpiece processing system.

The method 1202 may proceed to decision block 1218, wherein a determination is made whether more workpieces are being supplied to the primary organization assembly 122/122′. For instance, the method may include determining whether the production run or shift has ended, whether workpieces are sensed in the workpiece receiving assembly 208/208′, whether workpieces are sensed in the workpiece supply assembly 218, etc. If there are more workpieces being supplied to the primary organization assembly 122/122′, the method may begin again at block 1210. If the workpiece supply has ended (e.g., the production shift has ended), the method may proceed to an end block.

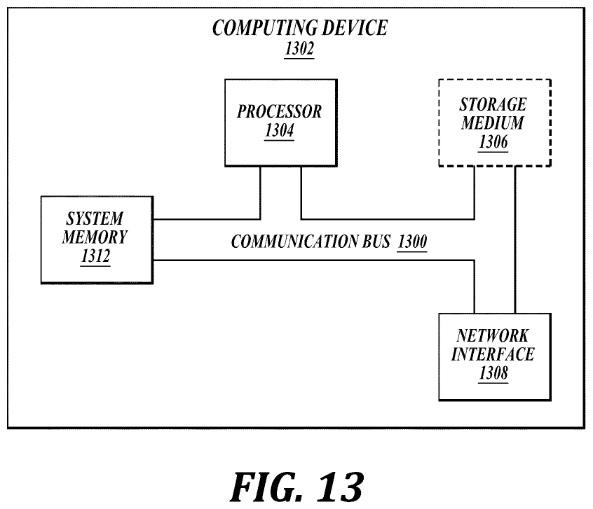

FIG. 13 is a block diagram that illustrates aspects of an exemplary computing device 1300 appropriate for use as a computing device of the present disclosure. While multiple different types of computing devices were discussed above, the exemplary computing device 1300 describes various elements that are common to many different types of computing devices. While FIG. 13 is described with reference to a computing device that is implemented as a device on a network, the description below is applicable to servers, personal computers, mobile phones, smart phones, tablet computers, embedded computing devices, and other devices that may be used to implement portions of examples of the present disclosure. Some examples of a computing device may be implemented in or may include an application-specific integrated circuit (ASIC), a field-programmable gate array (FPGA), or other customized device. Moreover, those of ordinary skill in the art and others will recognize that the computing device 1300 may be any one of any number of currently available or yet to be developed devices.

In its most basic configuration, the computing device 1300 includes at least one processor 1302 and a system memory 1310 connected by a communication bus 1308. Depending on the exact configuration and type of device, the system memory 1310 may be volatile or nonvolatile memory, such as read only memory (“ROM”), random access memory (“RAM”), EEPROM, flash memory, or similar memory technology. Those of ordinary skill in the art and others will recognize that system memory 1310 typically stores data and/or program modules that are immediately accessible to and/or currently being operated on by the processor 1302. In this regard, the processor 1302 may serve as a computational center of the computing device 1300 by supporting the execution of instructions.

As further illustrated in FIG. 13, the computing device 1300 may include a network interface 1306 comprising one or more components for communicating with other devices over a network. Examples of the present disclosure may access basic services that utilize the network interface 1306 to perform communications using common network protocols. The network interface 1306 may also include a wireless network interface configured to communicate via one or more wireless communication protocols, such as Wi-Fi, 2G, 3G, LTE, WiMAX, Bluetooth, Bluetooth low energy, and/or the like. As will be appreciated by one of ordinary skill in the art, the network interface 1306 illustrated in FIG. 13 may represent one or more wireless interfaces or physical communication interfaces described and illustrated above with respect to particular components of the computing device 1300.

In the example depicted in FIG. 13, the computing device 1300 also includes a storage medium 1304. However, services may be accessed using a computing device that does not include means for persisting data to a local storage medium. Therefore, the storage medium 1304 depicted in FIG. 13 is represented with a dashed line to indicate that the storage medium 1304 is optional. In any event, the storage medium 1304 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like.

Suitable implementations of computing devices that include a processor 1302, system memory 1310, communication bus 1308, storage medium 1304, and network interface 1306 are known and commercially available. For ease of illustration and because it is not important for an understanding of the claimed subject matter, FIG. 13 does not show some of the typical components of many computing devices. In this regard, the computing device 1300 may include input devices, such as a keyboard, keypad, mouse, microphone, touch input device, touch screen, tablet, and/or the like. Such input devices may be coupled to the computing device 1300 by wired or wireless connections including RF, infrared, serial, parallel, Bluetooth, Bluetooth low energy, USB, or other suitable connections protocols using wireless or physical connections. Similarly, the computing device 1300 may also include output devices such as a display, speakers, printer, etc. Since these devices are well known in the art, they are not illustrated or described further herein.

While the concepts of the present disclosure are susceptible to various modifications and alternative forms, specific examples thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

For instance, any of the components of the primary organization assembly 122, primary organization assembly 122′, organization assessment assembly 124, organization assessment assembly 124′, secondary organization assembly 126, and/or secondary organization assembly 126′ may be used with any of the other corresponding assemblies. Moreover, it should be appreciated that any of the assemblies or subassemblies described herein may be used independent of the other assemblies or subassemblies. For instance, a workpiece processing system may be used solely with a primary organization assembly 122/122′ to optimize infeed of workpieces. In other instances, a primary organization assembly 122/122′ and organization assessment assembly 124/124′ may only be used. In other instances, an organization assessment assembly 124/124′ and secondary organization assembly 126/126′ may only be used. Thus, the descriptions and illustrations provided herein should not limit interpretation of the claims, and further claims are understood to fall within the scope of the disclosure.

References in the specification to “one example,” “an example,” etc., indicate that the example described may include a particular feature, structure, or characteristic, but every example may or may not necessarily include that particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described. Additionally, it should be appreciated that items included in a list in the form of “at least one A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C).

Language such as “up”, “down”, “left”, “right”, “first”, “second”, etc., in the present disclosure is meant to provide orientation for the reader with reference to the drawings and is not intended to be the required orientation of the components or graphical images or to impart orientation limitations into the claims.

In the drawings, some structural or method features may be shown in specific arrangements and/or orderings. However, it should be appreciated that such specific arrangements and/or orderings may not be required. Rather, in some examples, such features may be arranged in a different manner and/or order than shown in the illustrative FIGS. Additionally, the inclusion of a structural or method feature in a particular FIG. is not meant to imply that such feature is required in all examples and, in some examples, it may not be included or may be combined with other features.

The present application may include modifiers such as the words “generally,” “approximately,” “about”, or “substantially.” These terms are meant to serve as modifiers to indicate that, for instance, the “dimension,” “shape,” “temperature,” “time,” or other physical parameter in question need not be exact, but may vary as long as the function that is required to be performed can be carried out.

As used herein, the terms “about”, “approximately,” etc., in reference to a number, is used herein to include numbers that fall within a range of 10%, 5%, or 1% in either direction (greater than or less than) the number unless otherwise stated or otherwise evident from the context (except where such number would exceed 100% of a possible value).

Where electronic or software components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Headings of sections provided in this patent application and the title of this patent application are for convenience only and are not to be taken as limiting the disclosure in any way.

While preferred examples of the present invention have been shown and described herein, it will be apparent to those skilled in the art that such examples are provided by way of example only. Numerous variations, changes, and substitutions will now occur to those skilled in the art without departing from the invention. Various alternatives to the examples of the invention described herein may be employed in practicing the invention. It is intended that the following claims define the scope of the invention and that methods and structures within the scope of these claims and their equivalents be covered.

The embodiments of the invention in which an exclusive property or privilege is claimed are defined as follows:

1. An automated infeed system, comprising:
a primary organization assembly configured to perform a primary workpiece organization to an aggregated supply of workpieces;
an organization assessment assembly having at least one sensor configured to capture sensor data regarding the primary workpiece organization;
a secondary organization assembly configured to perform a secondary workpiece organization based on the sensor data regarding the primary workpiece organization;
a controller configured to activate components of the secondary organization assembly to perform a secondary workpiece organization based on the sensor data; and
a movement assembly configured to move workpieces within the automated infeed system.

2. The automated infeed system of claim 1, wherein a workpiece flow distribution assembly is configured for distributing workpieces across at least one of a length and width of the movement assembly and includes at least one of:
a staggered roller assembly; and
at least first and second conveyors arranged in series, the first conveyor configured to move at a first speed and the second conveyor configured to move at a second speed different than the first speed.

3. The automated infeed system of claim 1, wherein the organization assessment assembly comprises a scanner station having at least one image sensor configured to capture image sensor data regarding the primary workpiece organization, wherein a computing device, using at least one of image sensor data and a 2D or 3D model of a workpiece generated from the image sensor data, is configured to perform at least one of:
determine a mass flow of workpieces through the organization assessment assembly;
output at least one of image sensor data and a 2D or 3D model of a workpiece generated from the image sensor data to a computing device for training a machine learning model;
output instructions to a diverting mechanism to divert a workpiece having one or more processing aspects unsuitable for processing by a workpiece processing system; and
execute a secondary organization algorithm to generate movement instructions for at least one secondary organization component of the secondary organization assembly to move a secondary organization component into a location for adjusting a position of a workpiece.

4. The automated infeed system of claim 1, further comprising at least one computing device configured to execute one or more machine learning models that output a workpiece organization plan using at least one of processed sensor data, workpiece type, and workpiece processing specifications as input, the workpiece organization plan including instructions for moving at least one secondary organization component of the secondary organization assembly into a location for adjusting a position of a workpiece.

5. The automated infeed system of claim 4, wherein training data for the one or more machine learning models includes at least one of:
workpiece type;
workpiece sensor data from the organization assessment assembly;
initial settings and any adjusted settings of one or more primary organization assembly components corresponding to information in the workpiece sensor data;
initial movement instructions and any adjusted movement instructions of one or more secondary organization components of the secondary organization assembly corresponding to information in the workpiece sensor data; and
initial settings and any adjusted settings of a workpiece processing system corresponding to information in the workpiece sensor data, the workpiece processing system receiving workpieces from the automated infeed system.

6. The automated infeed system of claim 5, wherein the workpiece sensor data includes at least one of a 2D or 3D model of a workpiece generated from image sensor data of the organization assessment assembly.

7. The automated infeed system of claim 1, wherein the secondary workpiece organization assembly includes at least a first prime mover array having first and second prime movers with corresponding first and second end effectors, the first and second prime movers locatable across a width of a movement support surface of the movement assembly such that the first prime mover is configured to locate its end effector in a first prime mover section defined by a first width of the movement support surface and the second prime mover is configured to locate its end effector in a second prime mover section defined by a second width of the movement support surface, wherein the first and second prime mover sections extend along substantially a same length of the movement support surface.

8. The automated infeed system of claim 7, wherein each of the first and second prime movers include:
a first linear actuator assembly having a first linear motor configured to move the corresponding end effector along a first linear movement axis that is substantially transverse to a longitudinal axis of the movement support surface, wherein the first linear actuator assembly is further configured to rotate the corresponding end effector about the first linear movement axis;
a second linear actuator assembly having a second linear motor configured to move the first linear actuator assembly along a second linear movement axis that is substantially transverse to the first linear movement axis; and
a third linear actuator assembly having a third linear motor configured to move the second linear actuator assembly along a third linear movement axis that is substantially transverse to the first and second linear movement axes.

9. A primary organization assembly configured to perform a primary workpiece organization to a bulk supply of workpieces, the primary organization assembly comprising:
a workpiece receiving assembly having a bulk supply receiving subassembly configured to receive a bulk supply of workpieces from a bulk storage transfer assembly;
a workpiece flow metering assembly configured to meter a mass flow of the bulk supply of workpieces through the primary organization assembly using at least one image sensor configured to obtain image sensor data of workpieces on a primary organization assembly conveyor;
a workpiece flow modulating assembly comprising:
a bulk supply deposit assembly configured to controllably deposit at least a portion of the bulk supply of workpieces from a bulk storage container to a buffering subassembly of the workpiece receiving assembly; and
a thickness control subsystem configured to cause at least one of stacked and overlapping workpieces to at least one of move back upstream for redistribution and to be substantially prevented from moving downstream with a movement assembly;
a workpiece flow distribution assembly configured to create separation of the workpieces in a direction of flow; and
a primary organization controller configured to output control instructions to the bulk supply deposit assembly to control at least one of a speed, a direction, and a frequency of the bulk supply deposit assembly based on the image sensor data of workpieces.

10. The primary organization assembly of claim 9, wherein the bulk supply deposit assembly is configured as a bulk storage container tipper configured to controllably move a bulk storage container rotationally between a receiving position, wherein the workpiece receiving assembly is configured to removably receive the bulk storage container, and a dumping position, wherein workpieces are configured to flow out of the bulk storage container into the buffering subassembly of the workpiece receiving assembly.

11. The primary organization assembly of claim 10, wherein the primary organization controller is configured to output control instructions to the bulk storage container tipper to control at least one of bulk storage tipper dumping rotational direction, bulk storage tipper dumping frequency, and bulk storage tipper dumping speed.

12. The primary organization assembly of claim 10, wherein the buffering subassembly of the workpiece receiving assembly includes a horizontally oriented hopper located generally below and downstream of the bulk storage container tipper and above the primary organization assembly conveyor such that workpieces deposited into the horizontally oriented hopper are moved downstream within the hopper on the primary organization assembly conveyor.

13. The primary organization assembly of claim 9, wherein a thickness control subsystem includes a first, fixed weir extending substantially transversely across the primary organization assembly conveyor at a downstream end of the buffering subassembly and a second, adjustable weir extending substantially transversely across the primary organization assembly conveyor downstream from the first, fixed weir, and wherein the workpiece flow metering assembly includes at least one image sensor configured to obtain image sensor data of workpieces on the primary organization assembly conveyor between the first and second weirs.

14. The primary organization assembly of claim 13, wherein a workpiece flow distribution assembly is located downstream of the thickness control subsystem and includes at least one of:
a roller array having a plurality of rollers arranged in series, each roller configured to run at a different speed; and
at least first and second conveyors arranged in series, the first conveyor configured to move at a first speed and the second conveyor configured to move at a second speed different than the first speed.

15. An automated infeed system, comprising:
a primary organization assembly configured to perform a primary workpiece organization to a bulk supply of workpieces, the primary organization assembly comprising:
a workpiece receiving assembly having a bulk supply receiving subassembly configured to receive a bulk supply of workpieces from a bulk storage transfer assembly;
a workpiece flow metering assembly configured to meter a mass flow of the bulk supply of workpieces through the primary organization assembly;
a workpiece flow modulating assembly comprising:
a bulk supply deposit assembly configured to controllably deposit at least a portion of the bulk supply of workpieces from a bulk container to a buffering subassembly of the workpiece receiving assembly; and
a thickness control subsystem configured to cause at least one of stacked and overlapping workpieces to at least one of move back upstream for redistribution and to be substantially prevented from moving downstream with a movement assembly; and
a workpiece flow distribution assembly configured to create separation of the workpieces in a direction of flow;
an organization assessment assembly having at least one sensor configured to capture sensor data regarding the primary workpiece organization;
a processor; and
a memory storing instructions that, when executed by the processor, cause a computing device of the automated infeed system to:
process the sensor data regarding the primary workpiece organization to determine at least one of workpiece mass flow, workpiece position, workpiece orientation, workpiece spacing, and workpiece arrangement; and
execute a primary organization algorithm based on the processed sensor data and workpiece processing specifications to generate modulating instructions for the workpiece flow modulating assembly including a bulk supply deposit assembly profile having at least one of a deposit speed, a deposit position, and a deposit frequency of the bulk supply deposit assembly.

16. The automated infeed system of claim 15, further comprising:
a secondary organization assembly configured to perform a secondary workpiece organization based on the sensor data regarding the primary workpiece organization; and
a movement assembly configured to move workpieces within the automated infeed system.

17. The automated infeed system of claim 16, wherein the memory storing instructions that, when executed by the processor, further cause a computing device of the automated infeed system to execute a secondary organization algorithm based on the processed sensor data and workpiece processing specifications to generate movement instructions for at least one secondary organization component of the secondary organization assembly to move a secondary organization component into a position for adjusting at least one of workpiece position, workpiece orientation, workpiece spacing, and workpiece arrangement.

18. The automated infeed system of claim 16, further comprising at least one computing device configured to execute one or more machine learning models that output a workpiece organization plan using at least one of processed sensor data, workpiece type, and workpiece processing specifications as input, the workpiece organization plan including instructions for moving at least one workpiece organization component of the secondary organization assembly into a location for adjusting a position of a workpiece.

19. The automated infeed system of claim 15, wherein the memory storing instructions that, when executed by the processor, further cause a computing device of the automated infeed system to execute one or more machine learning models that output a primary organization assembly score using sensor data regarding the primary workpiece organization as input, wherein the primary organization assembly score is indicative of primary organization assembly efficacy based on at least one of several categories, including workpiece belt loading density, percentage of workpiece overlaps, percentage of stacked workpieces, average spacing between workpieces, percentage of workpieces within an orientation specification, percentage of workpieces within an arrangement specification, and gaps in continuous flow of workpieces.

20. The automated infeed system of claim 19, wherein the memory storing instructions that, when executed by the processor, further cause a computing device of the automated infeed system to execute one or more machine learning models that output a primary organization assembly plan using at least one of a primary organization assembly score and workpiece processing specifications as input.

21. The automated infeed system of claim 20, wherein the primary organization assembly score is based on at least one of spacing between workpieces after passing the primary organization assembly, a percentage of overlapping workpieces after passing the primary organization assembly, a percentage of stacked workpieces after passing the primary organization assembly, a size of workpieces, a type of workpieces, a percentage of workpieces within an orientation specification, a percentage of workpieces within an arrangement specification, and at least one of a 2D or 3D model of a workpiece generated from image sensor data of the organization assessment assembly.

22. The automated infeed system of claim 15, wherein the organization assessment assembly comprises a scanner station having at least one image sensor configured to capture image sensor data regarding the primary workpiece organization, wherein a computing device, using at least one of image sensor data and a 2D or 3D model of a workpiece generated from the image sensor data, is configured to perform at least one of:
determine a mass flow of workpieces through the organization assessment assembly;
output at least one of image sensor data and a 2D or 3D model of a workpiece generated from the image sensor data to a computing device for training a machine learning model;
output instructions to a diverting mechanism to divert a workpiece having one or more processing aspects unsuitable for processing by a workpiece processing system; and
execute a workpiece organization algorithm to generate movement instructions for at least one workpiece organization component of a secondary organization assembly to move a workpiece organization component into a location for adjusting a position of a workpiece.
